(19) United States
(12) Patent Application Publication
(10) Pub. No.: US 2025/0126540 A1
(43) Pub. Date: Apr. 17, 2025

(54) METHOD AND DEVICE FOR CONTROLLING CONDITIONAL HANDOVER

(71) Applicant: GUANGDONG OPPO MOBILE TELECOMMUNICATIONS CORP., LTD., Dongguan (CN)

(72) Inventors: Jiangsheng FAN, Dongguan (CN); Xin YOU, Dongguan (CN); Xue LIN, Dongguan (CN)

(21) Appl. No.: 18/987,717

(22) Filed: Dec. 19, 2024

Related U.S. Application Data
(63) Continuation of application No. PCT/CN2022/101558, filed on Jun. 27, 2022.

(51) Int. Cl. H04W 36/36

(52) U.S. Cl. CPC H04W 36/362

(57) ABSTRACT

A method for controlling a conditional handover and network devices. A fourth network device receives a fourth message sent by a first network device. The fourth message is configured for conditional handover control; the first network device is at least one of a primary cell (PCell), a master node (MN), or a secondary node (SN) currently connected to a terminal device; and the fourth network device is at least one of a PCell, an MN, or an SN connected to the terminal device after conditional handover of the terminal device.

### CROSS-REFERENCE TO RELATED APPLICATION

This application is a continuation of International Application No. PCT/CN2022/101558 filed on Jun. 27, 2022, and entitled “CONDITIONAL HANDOVER CONTROL METHOD AND DEVICES”, the disclosure of which is incorporated herein by reference in its entirety.

### TECHNICAL FIELD

The disclosure relates to the field of communications, and in particularly to a method and device for controlling a conditional handover.

### RELATED ART

In a conditional handover mechanism, after receiving conditional handover configuration information configured by a network device, a terminal device begins to evaluate whether a handover condition associated with each conditional handover candidate cell is satisfied. When the handover condition associated with at least one conditional handover candidate cell is satisfied, the terminal device selects a conditional handover candidate cell satisfying the handover condition to initiate a handover procedure. Once a conditional handover procedure is successfully performed, the terminal device will delete all conditional handover configurations.

### SUMMARY

Embodiments of the disclosure provide a method for controlling a conditional handover, a fourth network device and a first network device.

An embodiment of the disclosure further provides a method for controlling a conditional handover, including the following operation.

A fourth network device receives a fourth message sent by a first network device, where the fourth message is configured for conditional handover control. The first network device is at least one of a primary cell (PCell), a master node (MN), or a secondary node (SN) currently connected to a terminal device; and the fourth network device is at least one of a PCell, an MN, or an SN connected to the terminal device after the conditional handover of the terminal device.

An embodiment of the disclosure further provides a first network device, including a processor and a memory, the memory is configured to store a computer program, and the processor is configured to call and run the computer program stored in the memory to cause the first network device to send a first message, where the first message is configured for conditional handover control. The first network device is at least one of a primary cell (PCell), a master node (MN), or a secondary node (SN) currently connected to a terminal device; and the fourth network device is at least one of a PCell, an MN, or an SN connected to the terminal device after conditional handover of the terminal device.

An embodiment of the disclosure further provides a fourth network device, including a processor and a memory, wherein the memory is configured to store a computer program, and the processor is configured to call and run the computer program stored in the memory to cause the fourth network device to receive a fourth message sent by a first network device, where the fourth message is configured for conditional handover control. The first network device is at least one of a primary cell (PCell), a master node (MN), or a secondary node (SN) currently connected to a terminal device; and the fourth network device is at least one of a PCell, an MN, or an SN connected to the terminal device after a conditional handover of the terminal device.

### BRIEF DESCRIPTION OF THE DRAWINGS

FIG. 1 is a schematic diagram of an application scenario according to an embodiment of the disclosure.

FIG. 2 is an overall flowchart of an exemplary method for controlling a conditional handover according to an embodiment of the disclosure.

FIG. 3 is a schematic flowchart of a method for controlling a conditional handover according to an embodiment of the disclosure.

FIG. 4 is a schematic flowchart of a method for controlling a conditional handover according to another embodiment of the disclosure.

FIG. 5 is a schematic flowchart of a method for controlling a conditional handover according to yet another embodiment of the disclosure.

FIG. 6 is a schematic flowchart of a method for controlling a conditional handover according to yet another embodiment of the disclosure.

FIG. 7 is a schematic flowchart of a method for controlling a conditional handover according to yet another embodiment of the disclosure.

FIG. 8 is a schematic flowchart of a method for controlling a conditional handover according to yet another embodiment of the disclosure.

FIG. 9 is a schematic flowchart of a method for controlling a conditional handover according to yet another embodiment of the disclosure.

FIG. 10 is a schematic flowchart of a method for controlling a conditional handover according to yet another embodiment of the disclosure.

FIG. 11 is a schematic flowchart of a method for controlling a conditional handover according to yet another embodiment of the disclosure.

FIG. 12 is a schematic flowchart of a method for controlling a conditional handover according to yet another embodiment of the disclosure.

FIG. 13 is a schematic flowchart of a method for controlling a conditional handover according to yet another embodiment of the disclosure.

FIG. 14 is a schematic flowchart of a method for controlling a conditional handover according to yet another embodiment of the disclosure.

FIG. 15 is a schematic structural diagram of a first network device according to an embodiment of the disclosure.

FIG. 16 is a schematic structural diagram of a first network device according to another embodiment of the disclosure.

FIG. 17 is a schematic structural diagram of a second network device according to an embodiment of the disclosure.

FIG. 18 is a schematic structural diagram of a second network device according to another embodiment of the disclosure.

FIG. 19 is a schematic structural diagram of a third network device according to an embodiment of the disclosure.

FIG. 20 is a schematic structural diagram of a third network device according to another embodiment of the disclosure.

FIG. 21 is a schematic structural diagram of a fourth network device according to an embodiment of the disclosure.

FIG. 22 is a schematic structural diagram of a fourth network device according to another embodiment of the disclosure.

FIG. 23 is a schematic structural diagram of a terminal device according to an embodiment of the disclosure.

FIG. 24 is a schematic structural diagram of a terminal device according to another embodiment of the disclosure.

FIG. 25 is a schematic block diagram of a communication device according to an embodiment of the disclosure.

FIG. 26 is a schematic block diagram of a chip according to an embodiment of the disclosure.

FIG. 27 is a schematic block diagram of a communication system according to an embodiment of the disclosure.

### DETAILED DESCRIPTION

The technical solutions in embodiments of the disclosure are described below with reference to the drawings for the embodiments of the disclosure.

The technical solutions in the embodiments of the disclosure may be applied to various communication systems, such as a global system of mobile communication (GSM), a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 5th-generation (5G) system or other communication systems.

Generally, conventional communication systems support a limited number of connections, which are easy to be implemented. However, with the development of communication technology, mobile communication systems will not only support conventional communications, but also support communications such as device to device (D2D) communication, machine to machine (M2M) communication, machine type communication (MTC), vehicle to vehicle (V2V) communication, or vehicle to everything (V2X) communication, etc. The embodiments of the disclosure may also be applied to these communication systems.

In an implementation, the communication system in the embodiments of the disclosure may be applied to a carrier aggregation (CA) scenario, a dual connectivity (DC) scenario, or a standalone (SA) network deployment scenario.

In an implementation, the communication system in the embodiments of the disclosure may be applied to an unlicensed spectrum. The unlicensed spectrum may also be considered as a shared spectrum. Alternatively, the communication system in the embodiments of the disclosure may also be applied to a licensed spectrum. The licensed spectrum may also be considered as a non-shared spectrum.

The embodiments of the disclosure are described in combination with at least one network device and a terminal device. Herein the terminal device may also be referred to as a user equipment (UE), an access terminal, a user unit, a user station, a mobile station, a mobile terminal, a remote station, a remote terminal, a mobile device, a user terminal, a terminal, a wireless communication device, a user agent, or a user device, etc.

The terminal device may be a station (ST) in a WLAN, a cellular telephone, a cordless telephone, a session initiation protocol (SIP) telephone, a wireless local loop (WLL) station, a personal digital assistant (PDA) device, a handheld device with a wireless communication function, a computing device or other processing device connected to a wireless modem, a vehicle-mounted device, a wearable device, a terminal device in a next generation communication system (e.g., an NR network), or a terminal device in a future evolutional public land mobile network (PLMN) network, etc.

In the embodiments of the disclosure, the terminal device may be deployed on the land, which may be indoor or outdoor, handheld, wearable, or vehicle-mounted; the terminal device may also be deployed on the water (e.g. deployed in a ship, etc.); and the terminal device may also be deployed in the air (e.g. deployed in an airplane, a balloon, a satellite, etc.).

In the embodiments of the disclosure, the terminal device may be a mobile phone, a pad, a computer with a wireless transceiver function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, and the like.

As an example rather than a limitation, in the embodiments of the disclosure, the terminal device may also be a wearable device. The wearable device may also be referred to as a wearable smart device, which is a general name of wearable devices developed by applying wearable technology to intelligently design daily wear, such as glasses, gloves, watches, clothes and shoes. The wearable device is a portable device that is worn directly on the body or integrated into the user's clothes or accessories. The wearable device is not only a kind of hardware device, but also realizes powerful functions through software support, data interaction and cloud interaction. In a broad sense, the wearable smart device includes devices (e.g. smart watches or smart glasses) that have various functions and a large size, and may realize complete or partial functions without relying on smart phones, and devices (e.g. various smart bracelets and smart jewelries for physical sign monitoring) that are only focus on certain functions, and need to cooperate with other devices such as smart phones.

In the embodiments of the disclosure, the network device may be a device for communicating with a mobile device, an access point (AP) in the WLAN, a base transceiver station (BTS) in the GSM or CDMA, a NodeB (NB) in the WCDMA, an evolutional Node B (eNB or eNodeB) in the LTE, a relay station or an AP, a vehicle-mounted device, a wearable device, a network device in the NR network (gNB), a network device in a future evolutional PLMN, or a network device in the NTN, and the like.

As an example rather than a limitation, in the embodiments of the disclosure, the network device may have movable characteristics, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may also be a base station set on the land, a water area, or the like.

In the embodiments of the disclosure, the network device may provide a service for a cell, the terminal device communicates with the network device through transmission resources (e.g., frequency domain resources, or spectrum resources) used by the cell. The cell may be a cell corresponding to the network device (e.g., a base station). The cell may belong to a macro base station or a base station corresponding to a small cell. The small cell may include a metro cell, a micro cell, a pico cell, a femto cell, and the like. The small cell has characteristics of small coverage and low transmission power, and is suitable for providing high-speed data transmission services.

According to the embodiments of the disclosure, the conditional handover is controlled through the first message, ensuring a continuity of service for the terminal device in a continuous conditional handover process.

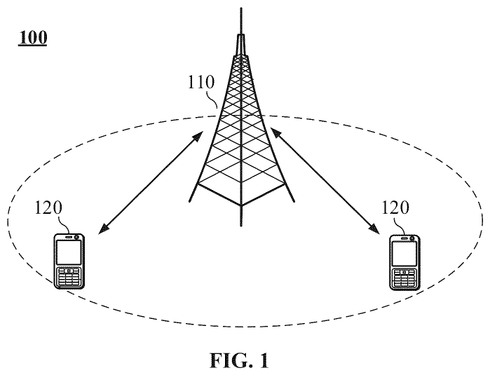

FIG. 1 exemplarily illustrates a communication system 100. The communication system includes one network device 110 and two terminal devices 120. In an embodiment, the communication system 100 may include multiple network devices 110, and the coverage range of each network device 110 may include other numbers of terminal devices 120, which is not limited in the embodiments of the disclosure.

In an embodiment, the communication system 100 may further include other network entities such as a mobility management entity (MME), an access and mobility management function (AMF), and the like, which are not limited in the embodiments of the disclosure.

Herein the network device may further include an access network device and a core network device. That is, the wireless communication system further includes multiple core networks for communicating with access network devices. The access network device may be an evolutional node B (eNB or e-NodeB) macro base station, a micro base station (also referred to as a “small base station”), a pico base station, an access point (AP), a transmission point (TP) or a new generation Node B (gNodeB) in a long-term evolution (LTE) system, a next radio (NR) system, or an authorized auxiliary access long-term evolution (LAA-LTE) system.

It should be understood that a device with a communication function in the network/system in the embodiments of the disclosure may be referred to as a communication device. Taking the communication system shown in FIG. 1 as an example, the communication device may include the network device and the terminal device with the communication function. The network device and the terminal device may be the specific devices in the embodiments of the disclosure, and will not be repeated herein. The communication device may further include other devices in the communication system, such as a network controller, a mobile management entity and other network entities, which are not limited in the embodiments of the disclosure.

It should be understood that the terms “system” and “network” are often used interchangeably herein. The term “and/or” herein is merely an association relationship describing association objects, and indicates that there may be three relationships. For example, A and/or B may indicate three cases: existence of A alone, existence of A and B simultaneously, and existence of B alone. Furthermore, the character “/” herein generally indicates that association objects before and after are in an “or” relationship.

It should be understood that the expression “indicate” mentioned in the embodiments of the disclosure may be a direct indication or an indirect indication, or may indicate that there is an association relationship. For example, A indicates B, which may indicate that A indicates B directly (e.g. B may be obtained through A), or may indicate that A indicates B indirectly (e.g. A indicates C, and B may be obtained through C), or may indicate that there is an association relationship between A and B.

In the description of the embodiments of the disclosure, the term “corresponding” may indicate that there is a direct correspondence relationship or an indirect correspondence relationship between the two, or may indicate that there is an association relationship between the two, or may indicate that there is a relationship of indicating and being indicated, configuring and being configured, and the like.

In order to facilitate understanding of the technical solutions in the embodiments of the disclosure, the related art of the embodiments of the disclosure is described below. The related art below may be arbitrarily combined with the technical solutions in the embodiments of the disclosure as options, and all of them belong to the scope of protection of the embodiments of the disclosure.

### 1. Conditional Handover Mechanism

Conditional primary cell (PCell) change, also referred to as conditional handover (CHO): a handover configuration message sent by a source PCell to a terminal device includes configuration information of at least one conditional handover target PCell and handover condition configuration information associated with the corresponding conditional handover target PCell.

Conditional primary secondary cell (PSCell) addition (CPA) or conditional PSCell change (CPC): a handover configuration message sent by a PCell or PSCell to the terminal device includes configuration information of at least one conditional addition target PSCell or conditional change target PSCell and handover condition configuration information associated with the corresponding conditional addition target PSCell or conditional change target PSCell.

The conditional handover mechanism (CHO, CPA, or CPC) of the related art generally adopts a two-step processing mode. At the first step, the terminal device receives conditional handover configurations configured by the network device, and the configurations include configuration information associated with at least one handover candidate cell. At the second step, after successfully receiving the conditional handover configuration information configured by the network device, the terminal device begins to evaluate whether a handover condition associated with each conditional handover candidate cell is satisfied. When the handover condition associated with at least one conditional handover candidate cell is satisfied, the terminal device selects a conditional handover candidate cell satisfying the handover condition to initiate a handover procedure. Once a conditional handover procedure is successfully performed, the terminal device will delete all conditional handover configurations.

### 2. Dual Connection (DC)

Under the DC architecture, a terminal device is simultaneously connected to two sets of cells. One of the two sets is referred to as a master cell group (MCG). The MCG includes at least one PCell. Optionally, the MCG may further include at least one secondary cell (SCell). Since all cells included in the MCG are usually deployed in one node, the MCG may also be referred to as a master node (MN) in many scenarios. Another set of cells to which the terminal device is connected is referred to as a secondary cell group (SCG). The SCG includes at least one primary cell, which is referred to as a PSCell. Optionally, the SCG may further include at least one SCell. Since all cells included in the SCG are usually deployed in one node, the SCG may also be referred to as a secondary node (SN) in many scenarios.

### 3. Data Forwarding

A communication system is composed of many cells, and each cell has a corresponding signal service range. As a terminal device moves, the terminal device will perform handover from one cell to another to ensure a continuity of service. The handover process involves a migration of a control entity, including the transition from user control management through a source cell before the handover to user control management through a new serving cell after the handover. Furthermore, the handover process further involves the forward forwarding of user data. The user data that needs to be forwarded mainly includes three parts: data that arrived at the source cell before the handover and which the source cell attempted to transmit to the terminal device but did not receive successful reception feedback from the terminal device, data that arrived at the source cell before the handover but which source cell did not have time to transmit to the terminal device, and new data sent from a core network to the source cell during the handover process (between the sending of a handover command from the source cell and the completion of a user data path switch operation for a handover target cell). The purpose of data forwarding is also to ensure the continuity of service for the terminal device.

In the conditional handover (CHO, CPC, or CPA) mechanism, the user data forwarding task of the network device during the handover process is single and unidirectional, because the terminal device will only select at most one conditional handover candidate cell to initiate the access procedure. Once the terminal device successfully completes the access, all conditional handover configuration information stored in the terminal device will be deleted. Therefore, a conditional handover process (or a single conditional handover configuration process) only involves one instance of data forwarding initiated by the source cell. Correspondingly, the direction of data forwarding can only be from the source cell of the terminal device to at least one conditional handover candidate cell.

However, for a continuous conditional handover scenario, after successfully performing the single conditional handover, the terminal device does not necessarily delete the configuration information related to at least one conditional handover candidate cell stored previously. Moreover, as long as the condition is satisfied, the terminal device may still use the stored conditional handover configuration to initiate a new conditional handover (i.e., the terminal device receives the conditional handover configuration once but performs multiple conditional handovers). Therefore, for the continuous conditional handover scenario, there may be a situation where data forwarding is triggered back and forth among multiple conditional handover candidate cells. For example, continuous conditional handover may involve multiple and multi-directional data forwardings.

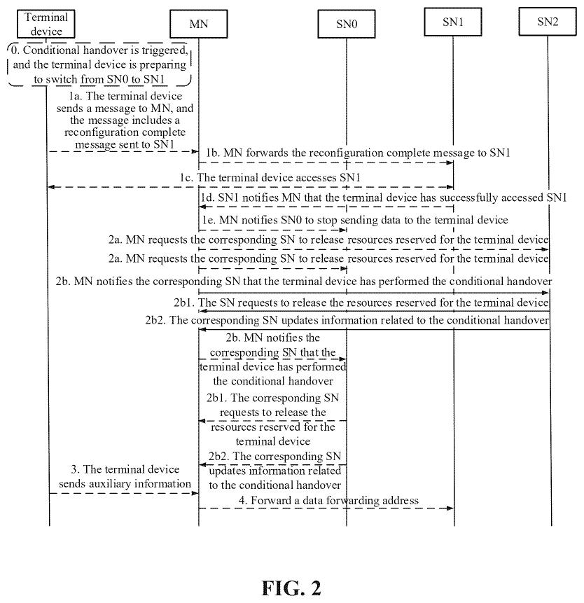

FIG. 2 is an overall flowchart of an exemplary method for controlling a conditional handover according to an embodiment of the disclosure. Herein SN0 is an SN (i.e., a source cell) currently connected to a terminal device, and SN1 is a target SN (i.e., a target cell) to which the terminal device is preparing to switch. SN2 is a conditional handover candidate cell of the terminal device. In FIG. 2, only some cases of the method for controlling the conditional handover are shown, not all implementations. Specific operations may vary depending on an actual application scenario.

As shown in FIG. 2, the method for controlling the conditional handover may include the following operations.

At operation 0, operation 0 is an optional operation, and the conditional handover is triggered. The terminal device is preparing to switch from SN0 to SN1 (SN1 is the target cell of the current round of conditional handover). Herein the conditional handover may be autonomously triggered by the terminal device, for example, when the handover condition configured by the network device is satisfied, or the conditional handover may be actively triggered by the network device, for example, the network device signals the terminal device to switch to a pre-configured conditional handover cell.

At operation 1a, the terminal device sends a message to MN, and the message includes a reconfiguration complete message sent to the SN.

At operation 1b, MN forwards the reconfiguration complete message to SN1.

Both operation 1a and operation 1b described above are optional operations. In an implementation, both operation 1a and operation 1b are performed, and in this implementation, the terminal device sends the reconfiguration complete message to SN1 through operation 1a and operation 1b. In another implementation, only operation 1b is performed, and in this implementation, MN sends the reconfiguration complete message or a conditional handover occurrence indication message to SN1, and the conditional handover occurrence indication message is configured to notify that SN1 is a conditional handover target cell that the terminal device is preparing to access.

Furthermore, the terminal device may directly send the reconfiguration complete message to SN1.

At operation 1c, operation 1c is an optional operation, and the terminal device accesses SN1 through operation 1c. The disclosure does not limit the logical sequence of operation 1a and operation 1c.

At operation 1d, operation 1d is an optional operation, and SN1 notifies MN that the terminal device has successfully accessed SN1 through operation 1d.

At operation 1e, operation 1e is an optional operation, and MN notifies SN0 to stop sending data to the terminal device. SN0 is the SN connected to the terminal device before the current round of conditional handover. The disclosure does not limit the logical sequence of operation 1e and any one of operations 1a to 1d.

At operation 2a, operation 2a is an optional operation. In an implementation, MN performs operation 2a to allow the corresponding SN (e.g., SN0 and/or SN2) participating in the conditional handover to release resources or configurations reserved for the terminal device. For example, if SN0 is no longer a conditional handover candidate cell for the terminal device, MN may request SN0 to release resources reserved for the terminal device. If SN2 is no longer a conditional handover candidate cell for the terminal device, MN may request SN2 to release resources reserved for the terminal device. Furthermore, if SN2 is no longer a conditional handover candidate cell for the terminal device, SN0 or SN1 may directly request SN2 to release resources reserved for the terminal device. The disclosure does not limit the logical sequence of operation 2a and any one of operations 1a to 1d.

At operation 2b, the target SN of the terminal device for the current round of conditional handover is SN1. SN0 and SN2 need to know the object of the round of conditional handover for the terminal device, and the notification process may be performed by MN. MN notifies the corresponding SN (e.g., SN0 and/or SN2) that the terminal device has performed the conditional handover. Furthermore, the notification process may be performed by SN0 or SN1, and SN0 or SN1 notifies the corresponding SN (e.g., SN2) that the terminal device has performed the conditional handover. The disclosure does not limit the logical sequence of operation 2b and any one of operations 1a to 1d. Operation 2a and operation 2b may exist simultaneously, and in this case, the set of target SNs for operation 2a is different from the set of target SNs for operation 2b.

At operation 2b1 and operation 2b2, both operation 2b1 and operation 2b2 are responses to operation 2b, but operation 2b1 and operation 2b2 may not be performed simultaneously. In an implementation, operation 2b1 is performed, and the SN receiving the notification requests to release the resources reserved for the terminal device. In this implementation, operation 2b1 is configured to reply MN or SN0 or SN1 that the corresponding SN wishes to release the resources or configurations reserved for the terminal device, or configured to notify MN or SN0 or SN1 that the corresponding SN has released the resources or configurations reserved for the terminal device. In another implementation, operation 2b2 is performed and is configured to notify MN of information related to the conditional handover updated by the corresponding SN.

At operation 3, operation 3 is an optional operation. The terminal device sends conditional handover auxiliary information to the network device through operation 3. The network device that receives the conditional handover auxiliary information is MN or an SN currently connected to the terminal device (e.g., SN0 connected to the terminal device before the handover, or SN1 connected to the terminal device after the handover). The disclosure does not limit the logical sequence of operation 3 and the other operations in FIG. 2.

At operation 4, operation 4 is an optional operation. MN or SN0 or SN2 sends a data forwarding address to the SN (e.g., SN1) connected to the terminal device after the conditional handover. SN1 triggers data forwarding tasks with other conditional handover related candidate SNs at an appropriate opportunity.

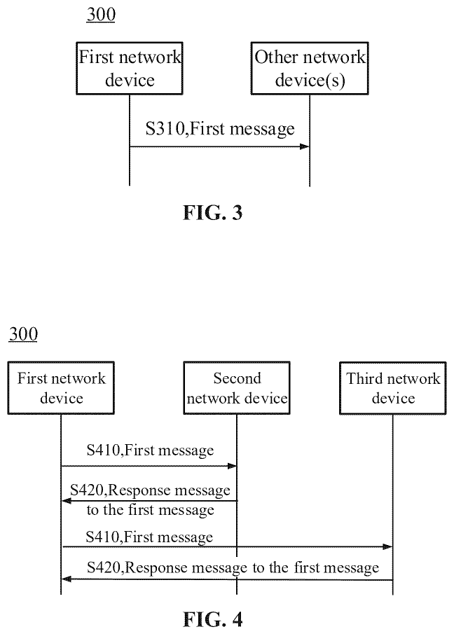

FIG. 3 is a schematic flowchart of a method 300 for controlling a conditional handover according to an embodiment of the disclosure. This method may optionally be applied to the system shown in FIG. 1, but is not limited thereto. The method includes at least part of the following.

At S310, a first network device sends a first message. The first message is configured for conditional handover control.

Herein the first network device is at least one of a primary cell (PCell), a master node (MN), or a secondary node (SN) currently connected to a terminal device.

In an embodiment of the disclosure, the conditional handover may include at least one of the following scenarios:

Conditional PCell handover (CHO);

Conditional PSCell addition (CPA); or

Conditional PSCell change (CPC).

In a continuous conditional handover scenario, the first network device may send the first message before, during, or after a certain round of conditional handover for a certain terminal device. The first message is configured for the next round of conditional handover control for the terminal device.

As shown in FIG. 4, in an implementation, the first network device sends the first message including the following operation S410.

At S410, the first network device sends the first message to a second network device and/or a third network device.

Herein the second network device is a conditional handover candidate cell associated with the terminal device, and the third network device is at least one of a PCell, an MN, or an SN connected to the terminal device before the conditional handover of the terminal device.

In the embodiment of the disclosure, the first network device sends the first message to the second network device and the first network device sends the first message to the third network device, and the two operations may be parallel or may have a sequence. Herein the second network device is the conditional handover candidate cell reserving resources for the terminal device before receiving the first message, and the third network device has the following different scenarios.

In an implementation, the conditional handover control may include adding a conditional handover candidate cell (which may also be referred to as a conditional handover related candidate cell), and specifically, may include requesting one cell to serve as a conditional handover candidate cell for the terminal device. For example, before receiving the addition request, a certain cell does not reserve resources for the terminal device. The third network device may be a source cell of the terminal device before the handover. Similar to adding the conditional handover candidate cell, the first network device sends the first message to the third network device (the source cell), and may request the third network device to serve as the conditional handover candidate cell for the terminal device.

In another implementation, unlike the process of adding the conditional handover candidate cell, the third network device is already a conditional handover candidate cell that reserves resources for the terminal device before receiving the first message. The first network device sends the first message to the third network device (the source cell), and may request the third network device to continue serving as the conditional handover candidate cell for the terminal device.

Referring to operation 2b in FIG. 2, the first network device is an initiator of the first message, and may be an MN connected to the terminal device (or may be a PCell or an SN connected to the terminal device). The second network device and the third network device may be receivers of the first message. The second network device may be other conditional handover candidate cell such as SN2. The third network device may be a cell (e.g., SN0) connected to the terminal device before the conditional handover of the terminal device. MN may send the first message to SN2 or SN0. For example, MN, SN0, or SN1 may notify SN2 that the terminal device has performed the conditional handover through the first message. For another example, MN may further notify the SN0 that the terminal device has performed the conditional handover through the first message.

In an implementation, a relationship between the first network device and the second network device includes at least one of:

the first network device is the PCell currently connected to the terminal device, and the second network device is a PCell related to the conditional handover associated with the terminal device;

the first network device is the MN currently connected to the terminal device, and the second network device is an MN related to the conditional handover associated with the terminal device; or

the first network device is the MN or the SN currently connected to the terminal device, and the second network device is an SN related to the conditional handover associated with the terminal device.

In the embodiment of the disclosure, the configuration of the conditional handover candidate cell associated with the terminal device includes that the network device configures at least one conditional handover candidate cell for the terminal device through a reconfiguration process. For the CHO scenario, the conditional handover candidate cell associated with the terminal device is at least one PCell related to the conditional handover. For the CPA or CPC scenario, the conditional handover candidate cell associated with the terminal device is at least one PSCell related to the conditional handover.

Exemplarily, an application scenario according to the embodiment of the disclosure includes at least one of the following scenario 1 to scenario 3.

Scenario 1: in a single connection scenario (non-DC scenario), the first network device is the PCell currently connected to the terminal device (regardless of whether before or after the conditional handover), and the second network device is the PCell related to the conditional handover associated with the terminal device.

Scenario 2: in the DC scenario and further in the CHO scenario, the first network device is the MN currently connected to the terminal device (regardless of whether before or after the conditional handover), and the second network device is the MN related to the conditional handover associated with the terminal device.

Scenario 3: in the DC scenario and further in the CPA or CPC scenario, the first network device is the MN or the SN currently connected to the terminal device (regardless of whether before or after the conditional handover), and the second network device is the SN related to the conditional handover associated with the terminal device.

In an implementation, a relationship between the first network device and the third network device includes at least one of:

the first network device is the PCell currently connected to the terminal device, and the third network device is the PCell connected to the terminal device before the conditional handover of the terminal device;

the first network device is the MN currently connected to the terminal device, and the third network device is the MN connected to the terminal device before the conditional handover of the terminal device; or

The first network device is the MN or the SN currently connected to the terminal device, and the third network device is the SN connected to the terminal device before the conditional handover of the terminal device.

Exemplarily, an application scenario according to the embodiment of the disclosure includes at least one of the following scenario 1 to scenario 3.

Scenario 1: in the single connection scenario (non-DC scenario), the first network device is the PCell currently connected to the terminal device, and the third network device is the PCell connected to the terminal device before the conditional handover of the terminal device.

Scenario 2: in the DC scenario and further in the CHO scenario, the first network device is the MN currently connected to the terminal device, and the third network device is the MN connected to the terminal device before the conditional handover of the terminal device.

Scenario 3: in the DC scenario and further in the CPA or CPC scenario, the first network device is the MN or the SN currently connected to the terminal device, and the third network device is the SN connected to the terminal device before the conditional handover of the terminal device.

In an implementation, the first message includes at least one of the following information 1-1 to information 1-8.

Information 1-1: a cell identifier corresponding to a conditional handover candidate cell accessed by the terminal device.

Examples of information 1-1: as shown in FIG. 2, the SN currently connected to the terminal device is SN0, and the target cell of the next round of conditional handover is SN1. The information 1-1 may include a cell identifier associated with a cell corresponding to SN1. Herein the cell identifier may be any one or more of the following forms: a logical number identifier associated with the conditional handover candidate cell, a cell global identifier (CGI), combination information of a physical cell identifier (PCI) and frequency corresponding to the cell, or a serving cell identifier (e.g., serving cell index) corresponding to the cell.

The above logical number identifier associated with the conditional handover candidate cell may be configured through the network. For example, under the conditional handover mechanism, the network device configures configuration information associated with at least one conditional handover candidate cell for the terminal device. In order to facilitate related operations on the configuration information associated with the conditional handover candidate cell, such as adding, updating, or deleting the configuration information associated with the conditional handover candidate cell, when configuring the configuration information associated with at least one conditional handover candidate cell, the network device assigns a logical number identifier to configuration information associated with each conditional handover candidate cell. For example, the network device configures configuration information associated with four conditional handover candidate cells for the terminal device, then the logical number identifiers assigned to the configuration information associated with the four conditional handover candidate cells may be 0, 1, 2, and 3, respectively.

Information 1-2: first indication information, where the first indication information is configured to indicate that the conditional handover candidate cell accessed by the terminal device is not a cell corresponding to the second network device and/or the third network device (i.e., the receiver of the first message).

Examples of information 1-2: if the first network device sends the first indication information to the second network device, the first indication information is configured to indicate that the conditional handover candidate cell accessed by the terminal device (i.e., the target cell in the current round of handover) is not the cell corresponding to the second network device. If the first network device sends the first indication information to the third network device, the first indication information is configured to indicate to the third network device that the terminal device has performed the conditional handover.

As shown in FIG. 2, the SN currently connected to the terminal device is SN0, and the target cell of the next round of conditional handover is SN1, then the MN (the initiator of the first message, which may also be the PCell or the SN) connected to the terminal device may send the first message to other conditional handover candidate cells (e.g., SN2). The first message may include the first indication information, configured to notify SN2 that the cell selected by the terminal device for the next round of conditional handover is not SN2. Then, SN2 may determine whether to continue serving as the conditional handover candidate cell for the terminal device based on information such as information 1-2 (other information included in the first message may further be referenced).

Information 1-3: second indication information, where the second indication information is configured to request the second network device and/or the third network device to provide a data forwarding address.

Examples of information 1-3: if the first network device sends the second indication information to the second network device, the second indication information is configured to request the second network device to provide a data forwarding address. If the first network device sends the second indication information to the third network device, the second indication information is configured to request the third network device to provide a data forwarding address.

As shown in FIG. 2, the SN currently connected to the terminal device is SN0, and the potential objects of data forwarding are SN1 and/or SN2. SN0 needs to obtain a data forwarding reception address of SN1 or SN2 before sending forwarding data to SN1 or SN2. Once the terminal device switches from SN0 to SN1, the source SN of the data forwarding changes from SN0 to SN1. However, SN1 does not know data forwarding addresses of the remaining conditional handover candidate cells (e.g., SN2). Then, the MN (the initiator of the first message, which may also be the PCell or the SN) connected to the terminal device may send the first message to other conditional handover candidate cells (e.g., SN2). The first message may include the second indication information, configured to request SN2 to provide a new data forwarding address.

Information 1-4: third indication information, where the third indication information is configured to request the second network device and/or the third network device to agree to serve as the conditional handover candidate cell for the terminal device.

Examples of information 1-4: if the first network device sends the third indication information to the second network device, the third indication information is configured to request the second network device to continue serving as the conditional handover candidate cell for the terminal device. If the first network device sends the third indication information to the third network device, the third indication information is configured to request the third network device to continue serving as the conditional handover candidate cell for the terminal device.

As shown in FIG. 2, the terminal device is connected to SN0 before the conditional handover, and the following scenarios may exist. Scenario 1: before the conditional handover, SN0 already belongs to one of the conditional handover candidate cells configured for the terminal device. Scenario 2: before the conditional handover, SN0 does not belong to one of the conditional handover candidate cells configured for the terminal device.

The SN currently connected to the terminal device is SN0, and the target cell of the next round of conditional handover is SN1. Since SN2 has not been selected as the target handover cell, the MN (the initiator of the first message, which may also be the PCell or the SN) connected to the terminal device may send the first message to other conditional handover candidate cells (e.g., SN2). The first message includes the third indication information, configured to request SN2 to continue serving as the conditional handover candidate cell for the terminal device. Of course, whether SN2 receives the above request will be determined by SN2.

Information 1-5: cell configuration information for the terminal device in a cell connected to the terminal device before the conditional handover. The cell connected to the terminal device before the conditional handover is at least one of a cell corresponding to the SN, a cell corresponding to the MN, or the PCell connected to the terminal device before the conditional handover.

Examples of information 1-5: cell configuration information for the terminal device in the cell corresponding to the SN, the cell corresponding to the MN, or the PCell connected to the terminal device before the conditional handover.

As shown in FIG. 2, the SN currently connected to the terminal device is SN0, and the information 1-5 may include cell configuration information for the terminal device in SN0. The MN (the initiator of the first message, which may also be the PCell or the SN) connected to the terminal device may send the first message to other conditional handover candidate cells (e.g., SN2). The first message includes the information 1-5, and after receiving the information 1-5, SN2 may determine whether to change the resources reserved for the terminal device or change the cell configuration information prepared for the terminal device.

For example, the cell configuration information may include at least one of the following configurations.

Non-access stratum (NAS) layer related configuration information, service data adaptation protocol (SDAP) layer related configuration information, radio resource control (RRC) layer related configuration information, packet data convergence protocol (PDCP) layer related configuration information, backhaul adaptation protocol (BAP) layer related configuration information, radio link control (RLC) layer related configuration information, media access control (MAC) layer related configuration information, or physical layer related configuration information.

Information 1-6: a cell measurement reported by the terminal device.

Information 1-7: location information of the terminal device.

Information 1-8: historical serving cell information of the terminal device.

Examples of information 1-6, information 1-7, and information 1-8: as shown in FIG. 2, the SN currently connected to the terminal device is SN0, and the target cell of the next round of conditional handover is SN1. Since SN2 has not been selected as the target handover cell, the MN (the initiator of the first message, which may also be the PCell or the SN) connected to the terminal device may send the first message to other conditional handover candidate cells (e.g., SN2). The first message includes at least one of information 1-6, information 1-7, or information 1-8, and is configured to request SN2 to continue serving as the conditional handover candidate cell for the terminal device. Of course, whether SN2 receives the above request will be determined by SN2.

The first message may explicitly include at least one of information 1-1 to information 1-8. Furthermore, the first message may also implicitly include some information, such as information 1-2 to information 1-4.

In an implementation, the first message is configured to at least one of:

Request the second network device and/or the third network device to provide a data forwarding address;

Request the second network device and/or the third network device to agree to serve as a conditional handover candidate cell for the terminal device; or

Indicate to the second network device and/or the third network device that the terminal device has performed the conditional handover.

For example, the second indication information may not be included in the first message sent by the first network device to the second network device and/or the third network device. Instead, the receiving device is implicitly requested to provide the data forwarding address through the first message.

For another example, the third indication information may not be included in the first message sent by the first network device to the second network device and/or the third network device. Instead, the receiving device is implicitly requested by the first message to determine whether to agree to serve as the conditional handover candidate cell for the terminal device.

For yet another example, the first indication information may not be included in the first message sent by the first network device to the second network device and/or the third network device. Instead, the receiving device is implicitly indicated by the first message that the conditional handover has performed.

In an implementation, the method further includes the following operation S420.

At S420, the first network device receives a response message to the first message sent by the second network device and/or the third network device.

In an implementation, the response message to the first message is configured to notify the first network device to remove configuration information reserved by the second network device and/or the third network device for the terminal device from conditional handover configuration information configured for the terminal device, that is, the second network device and/or the third network device are unwilling to continue serving as the conditional handover candidate cell associated with the terminal device.

Further, if the response message to the first message is configured to notify the first network device to remove the configuration information reserved by the second network device and/or the third network device for the terminal device from the conditional handover configuration information configured for the terminal device, the second network device and/or the third network device may send a resource release message to the terminal device directly or indirectly (e.g. through the MN). The resource release message may indicate that the terminal device needs to remove the information of the second network device and/or the third network device from the conditional handover configuration information stored in the terminal device.

For example, referring to FIG. 2, after operation 2b, operation 2b1 or operation 2b2 may be performed, and the network device (e.g., SN2) receiving the first message may return a response message to the first message to the MN (the initiator of the first message, which may also be the PCell or the SN connected to the terminal device). The response message to the first message is configured to respond to the request of the message initiator to release the resources reserved for the terminal device. After receiving the response message to the first message, the MN may remove the configuration information reserved by SN2 for the terminal device from the locally stored conditional handover configuration information configured for the terminal device.

In an implementation, the response message to the first message is configured to notify the first network device that the second network device and/or the third network device agree to serve as the conditional handover candidate cell for the terminal device.

In an implementation, in case that the response message to the first message is configured to notify the first network device that the second network device and/or the third network device agree to serve as the conditional handover candidate cell for the terminal device, the response message to the first message includes at least one of the following information 2-1 to information 2-4.

Information 2-1: a data forwarding address allocated by the second network device and/or the third network device.

Information 2-2: cell configuration information configured or updated for the terminal device by a cell corresponding to the second network device and/or the third network device. For the cell configuration information of the information 2-2, please refer to the relevant description of the above information 1-5, and will not be repeated here.

Information 2-3: valid duration information for the cell corresponding to the second network device and/or the third network device agreeing to serve as the conditional handover candidate cell for the terminal device.

Examples of information 2-3: In one case, the first network device receives the response message to the first message from the second network device, and the response message to the first message includes valid duration information for a cell corresponding to the second network device continuing to serve as the conditional handover candidate cell for the terminal device. In another case, the first network device receives the response message to the first message from the third network device, and the response message to the first message includes valid duration information for a cell corresponding to the third network device continuing to serve as the conditional handover candidate cell for the terminal device.

For example, the resource reservation behavior per se of the conditional handover candidate cell can be considered a waste of network resources. By setting the valid duration information of the conditional handover candidate cell, the corresponding reserved resources may be released when the reserved duration expired, thus improving the resource reservation efficiency of the communication system. Optionally, within the valid duration, the MN (the initiator of the first message, which may also be the PCell or the SN) connected to the terminal device may renegotiate a new valid duration with the conditional handover candidate cell. After the renegotiation is successful, a new valid duration will be timed.

Information 2-4: a cell identifier allocated by the second network device and/or the third network device for itself as the conditional handover candidate cell. For the cell identifier of the information 2-4, please refer to the relevant description of the above information 1-1, and will not be repeated here.

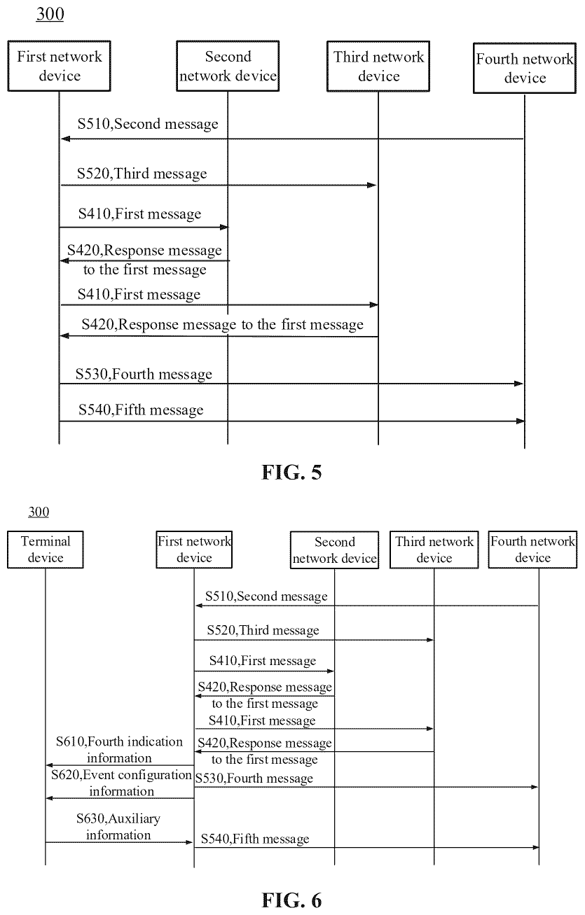

As shown in FIG. 5, in an implementation, the method further includes the following operation S510.

At S510, the first network device receives a second message sent by a fourth network device. The second message is configured to notify the first network device that the terminal device has successfully accessed or switched to the fourth network device.

Herein the fourth network device is at least one of a PCell, an MN, or an SN connected to the terminal device after the conditional handover of the terminal device.

Exemplarily, the first network device may be MN connected to the terminal device in FIG. 2, and the fourth network device may be SN1 (i.e., the target cell of this round of handover) connected to the terminal device after this round of conditional handover in FIG. 2. Referring to operation 1d, SN1 may notify the MN that the terminal has successful accessed SN1 through the second message.

In an implementation, the method further includes the following operation S520.

At S520, the first network device sends a third message to a third network device. The third message is configured to notify the third network device to stop sending data to the terminal device.

Herein the third network device is at least one of a PCell, an MN, or an SN connected to the terminal device before the conditional handover of the terminal device.

Exemplarily, the first network device may be MN connected to the terminal device in FIG. 2, and the third network device may be SN0 connected to the terminal device before the current round of conditional handover in FIG. 2. Referring to operation 1e, MN may notify SN0 to stop sending data to the terminal device through the third message.

In an implementation, the method further includes the following operation S530.

At S530, the first network device sends a fourth message to a fourth network device. The fourth message is configured for conditional handover control.

Herein the fourth network device is at least one of a PCell, an MN, or an SN connected to the terminal device after the conditional handover of the terminal device.

In an embodiment of the disclosure, the fourth network device may be a target cell (e.g., SN1 in FIG. 2) in the current round of conditional handover. Referring to operation 4, if the first network device is MN and the fourth network device is SN1, MN may send a data forwarding address to SN1 through the fourth message. SN1 triggers data forwarding tasks with other conditional handover candidate SNs at an appropriate opportunity.

In an implementation, the fourth message includes:

a data forwarding address allocated by the second network device and/or the third network device; and/or

valid duration information for a cell corresponding to the second network device and/or the third network device serving as the conditional handover candidate cell for the terminal device.

The data forwarding address allocated by the second network device and/or the third network device included in the fourth message may have the following examples.

Example 1: the data forwarding address is obtained through the response message to the first message (refer to information 2-1), that is, the data forwarding address is re-obtained through the response message to the first message.

Example 2: reusing previously allocated data forwarding addresses. Exemplarily, initially, the terminal device is connected to SN0. SN1 and SN2 send their data forwarding addresses to MN. MN then sends the data forwarding addresses of SN1 and SN2 to SN0 at an appropriate time. After one round of conditional handover, the terminal device switches from SN0 to SN1. Then, MN may forward the stored data forwarding address allocated by SN2 to SN1, for data forwarding from SN1 to SN2. In the above scenario, MN does not reapply for a new data forwarding address from SN2, but forwards the address sent to SN0 to SN1.

Further, the fourth network device may trigger the data forwarding at an appropriate time after obtaining the data forwarding address allocated by the other conditional handover candidate cell. In this way, once the next round of conditional handover of the terminal device is triggered, for example, the terminal device switches from SN1 to SN2, then the SN2 cell may promptly send user data to the terminal device after the terminal device is accessed, so as to ensure the continuity of user service.

In an implementation, the method further includes the following operation S540.

At S540, the first network device sends a fifth message to the fourth network device. The fifth message is configured to assist at least one of the PCell, the MN, or the

SN currently connected to the terminal device in data forwarding.

In an implementation, the fifth message includes at least one of:

at least one cell identifier for which trigger of the data forwarding is recommended;

at least one data forwarding address for which trigger of the data forwarding is recommended;

at least one cell identifier for which trigger of the data forwarding is not recommended;

at least one data forwarding address for which trigger of the data forwarding is not recommended;

at least one cell measurement reported by the terminal device; or

location information of the terminal device.

Exemplarily, the first network device may be MN connected to the terminal device in FIG. 2, and the fourth network device may be SN1 connected to the terminal device after the current round of conditional handover in FIG. 2. After the terminal device switches to SN1, SN1 needs to perform data forwarding to SN0 or SN2 at an appropriate time. However, the timing for data forwarding is difficult to determine. If the data forwarding is performed too early, the terminal device does not perform the next round of handover for a long time, and the previously forwarded data will waste network transmission and storage resources. If the data forwarding is performed too late, there may be a problem that the terminal device needs to additionally wait for the data forwarding after switching to the new cell, thus causing a poor user experience. Therefore, the first network device MN may send the fifth message to the fourth network device SN1. The fifth message may assist the fourth network device in triggering data forwarding at an appropriate opportunity. On one hand, the user experience is ensured, and on the other hand, the waste of network resources is reduced as much as possible.

The meaning of the cell identifier in the fifth message may refer to the relevant description of the above information 1-1, and will not be repeated here.

The information included in the fifth message may be determined based on auxiliary information reported by the terminal device, or may be determined autonomously by the network device that sends the fifth message.

In the embodiment of the disclosure, there is no limitation on the timing sequence of sending the first message, the second message, the third message, the fourth message, and the fifth message, which may be flexibly set according to the actual scenario.

As shown in FIG. 6, in an implementation, the method further includes the following operation S610.

At S610, the first network device sends fourth indication information to the terminal device, where the fourth indication information is configured to trigger the terminal device to report the auxiliary information.

In an implementation, the method further includes the following operation S620.

At S620, the first network device sends event configuration information to the terminal device, where the event configuration information is configured to configure configurations associated with an event related to reporting of the auxiliary information. For the configuration method, please refer to event type 2 or event type 3 in the following examples.

In an implementation, the event configuration information includes at least one of:

an event type identifier corresponding to the event related to the reporting of the auxiliary information;

a reporting period corresponding to the event related to the reporting of the auxiliary information;

a number of reports corresponding to the event related to the reporting of the auxiliary information; or

a threshold of triggering the reporting corresponding to the event related to the reporting of the auxiliary information.

In an embodiment of the disclosure, only one operation of sending the fourth indication information and sending the event configuration information may be performed, or both the operations may be performed, and the two operations may not have a chronological order relationship.

In the embodiment of the disclosure, from the perspective of the terminal device, triggering events for the reporting of the auxiliary information may include the following event type 1 to event type 3.

Event type 1: trigger by the network device sending indication information.

When the terminal device receives the indication information sent by the first

network device or the fourth network device, the terminal device triggers the reporting of the auxiliary information.

Event type 2: trigger by a protocol predefined event.

In this trigger manner, the event that triggers the terminal device to report the auxiliary information is not notified to the terminal device by the network device, but is default by the protocol. However, the configuration related to the default event may be configured to the terminal device through dedicated signaling sent by the network device, or may be default by the protocol.

Event type 3: trigger by an event dynamically configured by the network device.

In this trigger manner, there may be multiple events that trigger the terminal device to report the auxiliary information. The network device sends the configuration related to the triggering event to the terminal device through dedicated signaling. The configuration includes an event type identifier and/or at least one parameter related to the corresponding event. Exemplarily, the at least one parameter related to the corresponding event may include at least one of a reporting period, a number of reports, or a threshold of triggering the reporting.

For example, the event corresponding to the event type 2 or the event type 3 may be any one of the following events:

a periodic reporting timer expires;

the terminal device starts to perform a conditional handover evaluation task;

the terminal device starts to perform the conditional handover evaluation task and a cell measurement of the PCell connected to the terminal device is less than or equal to a fifth threshold;

the terminal device starts to perform the conditional handover evaluation task and the cell measurement of the PSCell connected to the terminal device is less than or equal to a sixth threshold; or

the terminal device stops performing the conditional handover evaluation task.

In an implementation, the method further includes the following operation S630.

At S630, the first network device receives the auxiliary information reported by the terminal device. The auxiliary information is related to conditional handover candidate cells. In an embodiment of the disclosure, operation S610 and/or operation S620 may be performed before operation S630, or only operation S630 may be performed, where the terminal device may independently determine to report the auxiliary information.

In an implementation, the auxiliary information includes at least one of the following auxiliary information:

auxiliary information 1: a cell identifier of a cell that will most be likely to perform a next conditional handover as the terminal device deduces;

auxiliary information 2: cell identifiers of cells that are likely to perform the next conditional handover as the terminal device deduces, with a maximum of M cell identifiers reported, where M is a positive integer;

auxiliary information 3: cell identifiers of N1 cells with best measurements among conditional handover candidate cells measured by the terminal device, where N1 is a positive integer;

auxiliary information 4: the cell identifiers and corresponding measurements of the N1 cells with the best measurements among the conditional handover candidate cells measured by the terminal device;

auxiliary information 5: cell identifiers of cells, each having a measurement greater than or equal to a first threshold, among the conditional handover candidate cells measured by the terminal device;

auxiliary information 6: the cell identifiers and corresponding measurements of the cells, each having a measurement greater than or equal to the first threshold, among the conditional handover candidate cells measured by the terminal device;

auxiliary information 7: cell identifiers of cells, each having a measurement greater than or equal to a second threshold, among the conditional handover candidate cells measured by the terminal device, with a maximum of N2 cell identifiers reported, where N2 is a positive integer;

auxiliary information 8: the cell identifiers and corresponding measurements of the cells, each having a measurement greater than or equal to the second threshold, among the conditional handover candidate cells measured by the terminal device, with a maximum of N2 cells reported;

auxiliary information 9: cell identifiers of cells, each having a ratio of a measurement to a triggering threshold of a corresponding conditional handover event that is greater than or equal to a third threshold, among the conditional handover candidate cells measured by the terminal device;

auxiliary information 10: the cell identifiers and corresponding measurements of the cells, each having a ratio of a measurement to the triggering threshold of the corresponding conditional handover event that is greater than or equal to the third threshold, among the conditional handover candidate cells measured by the terminal device;

auxiliary information 11: cell identifiers of cells, each having a ratio of a measurement to the triggering threshold of the corresponding conditional handover event that is greater than or equal to a fourth threshold, among the conditional handover candidate cells measured by the terminal device, with a maximum of N3 cells reported, where N3 is a positive integer; or

auxiliary information 12: the cell identifiers and corresponding measurements of the cells, each having a ratio of a measurement to the triggering threshold of the corresponding conditional handover event that is greater than or equal to the fourth threshold, among the conditional handover candidate cells measured by the terminal device, with the maximum of N3 cells reported.

Regarding auxiliary information 9 to auxiliary information 12, exemplarily, assuming that a measurement of a conditional handover candidate cell A currently measured by the terminal device is W1, and a triggering threshold corresponding to a conditional handover event associated with the conditional handover candidate cell A is W2, if a ratio of W1 to W2 is greater than or equal to the corresponding threshold, then it is considered that the auxiliary information related to the cell may be reported when the reporting event is triggered (see the description below).

The meaning of the cell identifier in the above auxiliary information may refer to the description of the above information 1-1, and will not be repeated here.

The above measurement may include a cell-level measurement and/or a beam-

level measurement. Herein the cell-level measurement or the beam-level measurement may include at least one of the following measurements: reference signal received power (RSRP), reference signal received quality (RSRQ), and signal to interference plus noise ratio (SINR).

At least one of the parameters M, N1, the first threshold, the second threshold, N2, the third threshold, N3, and the fourth threshold is configured in at least one of the following manners: a protocol default configuration manner, a system broadcast message manner, or a terminal device-dedicated signaling manner.

The method for controlling the conditional handover according to the embodiment of the disclosure may solve the problem of data forwarding between different candidate cells during the continuous conditional handover, and ensure the continuity of service for the terminal device during the continuous conditional handover.

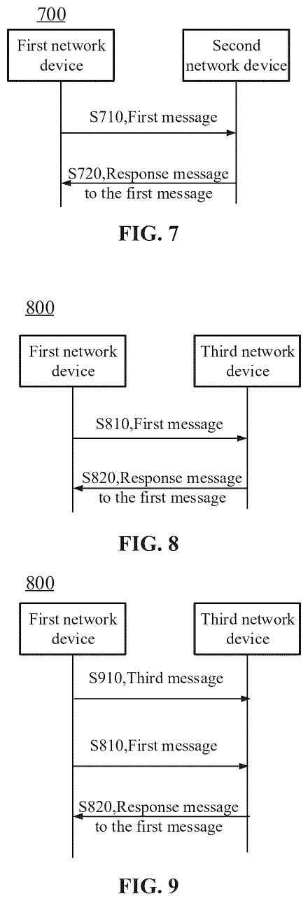

FIG. 7 is a schematic flowchart of a method 700 for controlling a conditional handover according to an embodiment of the disclosure. The method may optionally be applied to the system shown in FIG. 1, but is not limited thereto. The method includes at least part of the following.

At S710, a second network device receives a first message sent by a first network device, where the first message is configured for conditional handover control.

Herein the first network device is at least one of a primary cell (PCell), a master node (MN), or a secondary node (SN) currently connected to a terminal device; and the second network device is a conditional handover candidate cell associated with the terminal device.

In an implementation, a relationship between the first network device and the second network device includes at least one of:

the first network device is the PCell currently connected to the terminal device, and the second network device is a PCell related to the conditional handover associated with the terminal device;

the first network device is the MN currently connected to the terminal device, and the second network device is an MN related to the conditional handover associated with the terminal device; or

the first network device is the MN or the SN currently connected to the terminal device, and the second network device is an SN related to the conditional handover associated with the terminal device.

In an implementation, the first message includes at least one of:

a cell identifier corresponding to a conditional handover candidate cell accessed by the terminal device;

first indication information, configured to indicate that the conditional handover candidate cell accessed by the terminal device is not a cell corresponding to the second network device;

second indication information, configured to request the second network device to provide a data forwarding address;

third indication information, configured to request the second network device to agree to continue serving as the conditional handover candidate cell for the terminal device;

cell configuration information for the terminal device in a cell connected to the terminal device before the conditional handover, where the cell connected to the terminal device before the conditional handover is at least one of a cell corresponding to an SN, a cell corresponding to an MN, or a PCell connected to the terminal device before the conditional handover;

a cell measurement reported by the terminal device;

location information of the terminal device; or

historical serving cell information of the terminal device.

In an implementation, the first message is configured to at least one of:

request the second network device to provide a data forwarding address;

request the second network device to agree to continue serving as the conditional handover candidate cell for the terminal device; or

indicate to the second network device that the terminal device has performed the conditional handover.

In an implementation, the method further includes the following operation S720.

At S720, the second network device sends a response message to the first message to the first network device.

Herein the response message to the first message is configured to notify the first network device to remove configuration information reserved by the second network device for the terminal device from conditional handover configuration information configured for the terminal device; or the response message to the first message is configured to notify the first network device that the second network device agrees to continue serving as the conditional handover candidate cell for the terminal device.

In an implementation, in case that the response message to the first message is configured to notify the first network device that the second network device agrees to continue serving as the conditional handover candidate cell for the terminal device, the response message to the first message includes at least one of:

a data forwarding address allocated by the second network device;

cell configuration information configured or updated for the terminal device by a cell corresponding to the second network device;

valid duration information for the cell corresponding to the second network device agreeing to continue serving as the conditional handover candidate cell for the terminal device; or

a cell identifier allocated by the second network device for itself as the conditional handover candidate cell.

For specific examples of the method 700 performed by the second network device according to the embodiment, please refer to the relevant description of the second network device in the above method 300, and the description thereof is not repeated here for the sake of brevity.

FIG. 8 is a schematic flowchart of a method 800 for controlling a conditional handover according to an embodiment of the disclosure. The method may optionally be applied to the system shown in FIG. 1, but is not limited thereto. The method includes at least part of the following.

At S810, a third network device receives a first message sent by a first network device. The first message is configured for conditional handover control.

Herein the first network device is at least one of a primary cell (PCell), a master node (MN), or a secondary node (SN) currently connected to a terminal device; and the third network device is at least one of a PCell, an MN, or an SN connected to the terminal device before the conditional handover of the terminal device.

In an implementation, the first message includes at least one of:

a cell identifier corresponding to a conditional handover candidate cell accessed by the terminal device;

first indication information, configured to indicate that the conditional handover candidate cell accessed by the terminal device is not a cell corresponding to the third network device;

second indication information, configured to request the third network device to provide a data forwarding address;

third indication information, configured to request the third network device to agree to serve as a conditional handover candidate cell for the terminal device;

cell configuration information for the terminal device in a cell connected to the terminal device before the conditional handover. The cell connected to the terminal device before the conditional handover is at least one of a cell corresponding to the SN, a cell corresponding to the MN, or the PCell connected to the terminal device before the conditional handover;

a cell measurement reported by the terminal device;

location information of the terminal device; or

historical serving cell information of the terminal device.

In an implementation, the first message is configured to at least one of:

request the third network device to provide a data forwarding address;

request the third network device to agree to serve as a conditional handover candidate cell for the terminal device; or

indicate to the third network device that the terminal device has performed the conditional handover.

In an implementation, the method further includes the following operation S820.

At S820, the third network device sends a response message to the first message to the first network device.

Herein the response message to the first message is configured to notify the first network device to remove configuration information reserved by the third network device for the terminal device from conditional handover configuration information configured for the terminal device; or the response message to the first message is configured to notify the first network device that the third network device agrees to serve as a conditional handover candidate cell for the terminal device.

In an implementation, in case that the response message to the first message is configured to notify the first network device that the third network device agrees to serve as the conditional handover candidate cell for the terminal device, the response message to the first message includes at least one of:

a data forwarding address allocated by the third network device;

cell configuration information configured or updated for the terminal device by a cell corresponding to the third network device;

valid duration information for the cell corresponding to the third network device agreeing to serve as the conditional handover candidate cell for the terminal device; or

a cell identifier allocated by the third network device for itself as the conditional handover candidate cell.

As shown in FIG. 9, in an implementation, the method further includes the following operation S910.

At S910, the third network device receives a third message sent by the first network device, where the third message is configured to notify the third network device to stop sending data to the terminal device.

For specific examples of the method 900 performed by the third network device according to the embodiment, please refer to the relevant description of the third network device in the above method 300, and the description thereof is not repeated here for the sake of brevity.

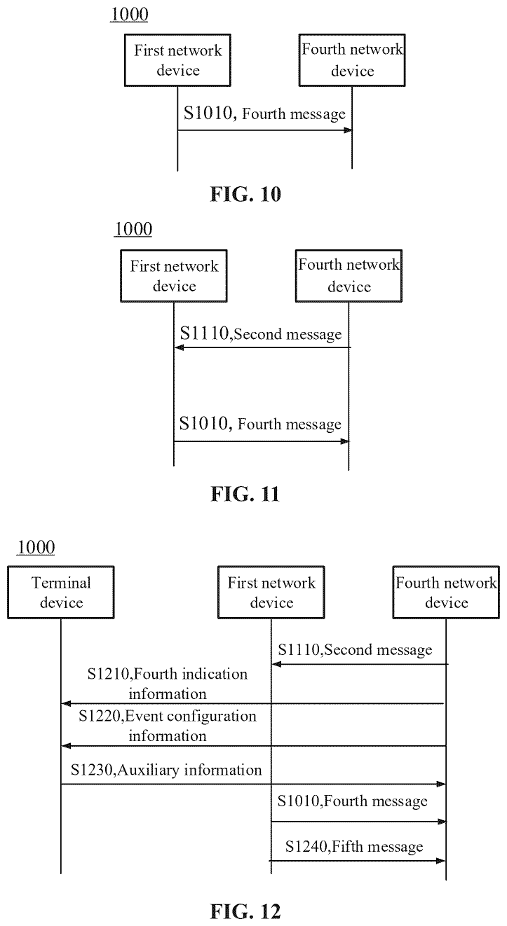

FIG. 10 is a schematic flowchart of a method 1000 for controlling a conditional handover according to an embodiment of the disclosure. The method may optionally be applied to the system shown in FIG. 1, but is not limited thereto. The method includes at least part of the following.

At S1010, a fourth network device receives a fourth message sent by a first network device, where the fourth message is configured for conditional handover control.

Herein the first network device is at least one of a primary cell (PCell), a master node (MN), or a secondary node (SN) currently connected to a terminal device; and the fourth network device is at least one of a PCell, an MN, or an SN connected to the terminal device after the conditional handover of the terminal device.

In an implementation, the fourth message includes:

a data forwarding address allocated by a second network device and/or a third network device; and/or

valid duration information for a cell corresponding to the second network device and/or the third network device serving as a conditional handover candidate cell for the terminal device.

As shown in FIG. 11, in an implementation, the method further includes the following operation S1110.

At S1110, the fourth network device sends a second message to the first network device. The second message is configured to notify the first network device that the terminal device has successfully accessed or switched to the fourth network device.

As shown in FIG. 12, in an implementation, the method further includes the following operation S1210.

At S1210, the fourth network device sends fourth indication information to the terminal device, where the fourth indication information is configured to trigger the terminal device to report auxiliary information.

In an implementation, the method further includes the following operation S1220.

At S1220, the fourth network device sends event configuration information to the terminal device, where the event configuration information is configured to configure configurations associated with an event related to reporting of the auxiliary information.

Herein the event configuration information includes at least one of:

an event type identifier corresponding to the event related to the reporting of the auxiliary information;

a reporting period corresponding to the event related to the reporting of the auxiliary information;

a number of reports corresponding to the event related to the reporting of the auxiliary information; or

a threshold of triggering the reporting corresponding to the event related to the reporting of the auxiliary information.

In an implementation, the method further includes the following operation S1230.

At S1230, the fourth network device receives the auxiliary information reported by the terminal device. The auxiliary information is related to conditional handover candidate cells.

In an implementation, the auxiliary information includes at least one of:

a cell identifier of a cell that will most be likely to perform a next conditional handover as the terminal device deduces;

cell identifiers of cells that are likely to perform the next conditional handover as the terminal device deduces, with a maximum of M cell identifiers reported;

cell identifiers of N1 cells with best measurements among conditional handover candidate cells measured by the terminal device;

the cell identifiers and corresponding measurements of the NI cells with the best measurements among the conditional handover candidate cells measured by the terminal device;

cell identifiers of cells, each having a measurement greater than or equal to a first threshold, among the conditional handover candidate cells measured by the terminal device;

the cell identifiers and corresponding measurements of the cells, each having a measurement greater than or equal to the first threshold, among the conditional handover candidate cells measured by the terminal device;

cell identifiers of cells, each having a measurement greater than or equal to a second threshold, among the conditional handover candidate cells measured by the terminal device, with a maximum of N2 cell identifiers reported;

the cell identifiers and corresponding measurements of the cells, each having a measurement greater than or equal to the second threshold, among the conditional handover candidate cells measured by the terminal device, with a maximum of N2 cells reported;

cell identifiers of cells, each having a ratio of a measurement to a triggering threshold of a corresponding conditional handover event that is greater than or equal to a third threshold, among the conditional handover candidate cells measured by the terminal device;

the cell identifiers and corresponding measurements of the cells, each having a ratio of a measurement to the triggering threshold of the corresponding conditional handover event that is greater than or equal to the third threshold, among the conditional handover candidate cells measured by the terminal device;

cell identifiers of cells, each having a ratio of a measurement to the triggering threshold of the corresponding conditional handover event that is greater than or equal to a fourth threshold, among the conditional handover candidate cells measured by the terminal device, with a maximum of N3 cells reported; or

the cell identifiers and corresponding measurements of the cells, each having a ratio of a measurement to the triggering threshold of the corresponding conditional handover event that is greater than or equal to the fourth threshold, among the conditional handover candidate cells measured by the terminal device, with the maximum of N3 cells reported.

In an implementation, the method further includes the following operation S1240.

At S1240, the fourth network device receives a fifth message sent by the first network device, where the fifth message is configured to assist at least one of the PCell, the MN, or the SN currently connected to the terminal device in data forwarding.

In an implementation, the fifth message includes at least one of:

at least one cell identifier for which trigger of the data forwarding is recommended;

at least one data forwarding address for which trigger of the data forwarding is recommended;

at least one cell identifier for which trigger of the data forwarding is not recommended;

at least one data forwarding address for which trigger of the data forwarding is not recommended;

at least one cell measurement reported by the terminal device; or

location information of the terminal device.

For specific examples of the method 1000 performed by the fourth network device according to the embodiment, please refer to the relevant description of the fourth network device in the above method 300, and the description thereof is not repeated here for the sake of brevity.

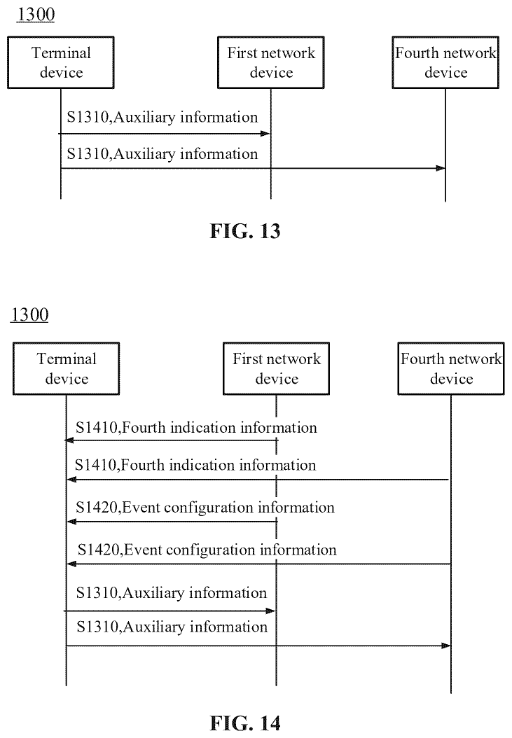

FIG. 13 is a schematic flowchart of a method 1300 for controlling a conditional handover according to an embodiment of the disclosure. The method may optionally be applied to the system shown in FIG. 1, but is not limited thereto. The method includes at least part of the following.

At S1310, a terminal device reports auxiliary information to a first network device and/or a fourth network device, where the auxiliary information is related to conditional handover candidate cells.

Herein the first network device is at least one of a primary cell (PCell), a master node (MN), or a secondary node (SN) currently connected to the terminal device; and the fourth network device is at least one of a PCell, an MN, or an SN connected to the terminal device after the conditional handover of the terminal device.

In an implementation, the auxiliary information includes at least one of:

a cell identifier of a cell that will most be likely to perform a next conditional handover as the terminal device deduces;

cell identifiers of cells that are likely to perform the next conditional handover as the terminal device deduces, with a maximum of M cell identifiers reported;

cell identifiers of N1 cells with best measurements among conditional handover candidate cells measured by the terminal device;

the cell identifiers and corresponding measurements of the N1 cells with the best measurements among the conditional handover candidate cells measured by the terminal device;

cell identifiers of cells, each having a measurement greater than or equal to a first threshold, among the conditional handover candidate cells measured by the terminal device;

the cell identifiers and corresponding measurements of the cells, each having a measurement greater than or equal to the first threshold, among the conditional handover candidate cells measured by the terminal device;

cell identifiers of cells, each having a measurement greater than or equal to a second threshold, among the conditional handover candidate cells measured by the terminal device, with a maximum of N2 cell identifiers reported;

the cell identifiers and corresponding measurements of the cells, each having a measurement greater than or equal to the second threshold, among the conditional handover candidate cells measured by the terminal device, with a maximum of N2 cells reported;

cell identifiers of cells, each having a ratio of a measurement to a triggering threshold of a corresponding conditional handover event that is greater than or equal to a third threshold, among the conditional handover candidate cells measured by the terminal device;

the cell identifiers and corresponding measurements of the cells, each having a ratio of a measurement to the triggering threshold of the corresponding conditional handover event that is greater than or equal to the third threshold, among the conditional handover candidate cells measured by the terminal device;

cell identifiers of cells, each having a ratio of a measurement to the triggering threshold of the corresponding conditional handover event that is greater than or equal to a fourth threshold, among the conditional handover candidate cells measured by the terminal device, with a maximum of N3 cells reported; or

the cell identifiers and corresponding measurements of the cells, each having a ratio of a measurement to the triggering threshold of the corresponding conditional handover event that is greater than or equal to the fourth threshold, among the conditional handover candidate cells measured by the terminal device, with the maximum of N3 cells reported.

As shown in FIG. 14, in an implementation, the method further includes the following operation S1410.

At S1410, the terminal device receives fourth indication information sent by the first network device and/or the fourth network device, where the fourth indication information is configured to trigger the terminal device to report the auxiliary information.

In an implementation, the reporting of the auxiliary information by the terminal device is triggered when a default event is satisfied or when an event configured by the first network device and/or the fourth network device is satisfied.

In an implementation, the method further includes the following operation S1420.

At S1420, the terminal device receives event configuration information sent by the first network device and/or the fourth network device, where the event configuration information is configured to configure configurations associated with an event related to the reporting of the auxiliary information.

Herein the event configuration information includes at least one of:

an event type identifier corresponding to the event related to the reporting of the auxiliary information;

a reporting period corresponding to the event related to the reporting of the auxiliary information;

a number of reports corresponding to the event related to the reporting of the auxiliary information; or

a threshold of triggering the reporting corresponding to the event related to the reporting of the auxiliary information.

For specific examples of the method 1300 performed by the terminal device according to the embodiment, please refer to the relevant description of the terminal device in the above method 300, and the description thereof is not repeated here for the sake of brevity.

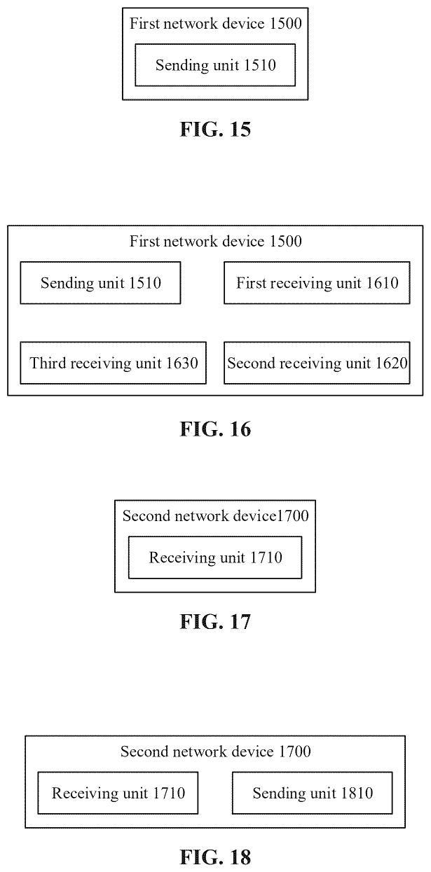

FIG. 15 is a schematic structural diagram of a first network device 1500 according to an embodiment of the disclosure. The first network device 1500 may optionally be applied to the system shown in FIG. 1, but is not limited thereto. The first network device 1500 includes at least part of the following.

A sending unit 1510 is configured to send a first message, where the first message is configured for conditional handover control.

Herein the first network device is at least one of a primary cell (PCell), a master node (MN), or a secondary node (SN) currently connected to a terminal device.

In an implementation, the sending unit 1510 is further configured to send the first message to a second network device and/or a third network device.

Herein the second network device is a conditional handover candidate cell associated with the terminal device, and the third network device is at least one of a PCell, an MN, or an SN connected to the terminal device before conditional handover of the terminal device.

In an implementation, a relationship between the first network device and the second network device includes at least one of:

the first network device is the PCell currently connected to the terminal device, and the second network device is a PCell related to the conditional handover associated with the terminal device;

the first network device is the MN currently connected to the terminal device, and the second network device is an MN related to the conditional handover associated with the terminal device; or

the first network device is the MN or the SN currently connected to the terminal device, and the second network device is an SN related to the conditional handover associated with the terminal device.

In an implementation, the first message includes at least one of:

a cell identifier corresponding to a conditional handover candidate cell accessed by the terminal device;

first indication information, configured to indicate that the conditional handover candidate cell accessed by the terminal device is not a cell corresponding to the second network device and/or the third network device;

second indication information, configured to request the second network device and/or the third network device to provide a data forwarding address;

third indication information, configured to request the second network device and/or the third network device to agree to serve as the conditional handover candidate cell for the terminal device;

cell configuration information for the terminal device in a cell connected to the terminal device before the conditional handover, where the cell connected to the terminal device before the conditional handover is at least one of a cell corresponding to an SN, a cell corresponding to an MN, or a PCell connected to the terminal device before the conditional handover;

a cell measurement reported by the terminal device;

location information of the terminal device; or

historical serving cell information of the terminal device.

In an implementation, the first message is configured to at least one of:

request the second network device and/or the third network device to provide a data forwarding address;

request the second network device and/or the third network device to agree to serve as a conditional handover candidate cell for the terminal device; or

indicate to the second network device and/or the third network device that the terminal device has performed the conditional handover.

In an implementation, as shown in FIG. 16, the first network device further includes a first receiving unit 1610.

The first receiving unit 1610 is configured to receive a response message to the first message sent by the second network device and/or the third network device.

Herein the response message to the first message is configured to notify the first network device to remove configuration information reserved by the second network device and/or the third network device for the terminal device from conditional handover configuration information configured for the terminal device; or the response message to the first message is configured to notify the first network device that the second network device and/or the third network device agree to serve as a conditional handover candidate cell for the terminal device.

In an implementation, in case that the response message to the first message is configured to notify the first network device that the second network device and/or the third network device agree to serve as the conditional handover candidate cell for the terminal device, the response message to the first message includes at least one of:

a data forwarding address allocated by the second network device and/or the third network device;

cell configuration information configured or updated for the terminal device by a cell corresponding to the second network device and/or the third network device;

valid duration information for the cell corresponding to the second network device and/or the third network device agreeing to serve as the conditional handover candidate cell for the terminal device; or

a cell identifier allocated by the second network device and/or the third network device for itself as the conditional handover candidate cell.

In an implementation, the first network device further includes a second receiving unit 1620.

The second receiving unit 1620 is configured to receive a second message sent by a fourth network device. The second message is configured to notify the first network device that the terminal device has successfully accessed or switched to the fourth network device.

Herein the fourth network device is at least one of a PCell, an MN, or an SN connected to the terminal device after the conditional handover of the terminal device.

In an implementation, the sending unit 1510 is further configured to send a third message to a third network device. The third message is configured to notify the third network device to stop sending data to the terminal device.

Herein the third network device is at least one of a PCell, an MN, or an SN connected to the terminal device before the conditional handover of the terminal device.

In an implementation, the sending unit 1510 is further configured to send a fourth message to a fourth network device. The fourth message is configured for conditional handover control.

Herein the fourth network device is at least one of a PCell, an MN, or an SN connected to the terminal device after the conditional handover of the terminal device.

In an implementation, the fourth message includes:

a data forwarding address allocated by a second network device and/or a third network device; and/or

valid duration information for a cell corresponding to the second network device and/or the third network device serving as a conditional handover candidate cell for the terminal device.

In an implementation, the sending unit 1510 is further configured to send a fifth message to the fourth network device, where the fifth message is configured to assist at least one of the PCell, the MN, or the SN currently connected to the terminal device in data forwarding.

In an implementation, the fifth message includes at least one of:

at least one cell identifier for which trigger of the data forwarding is recommended;

at least one data forwarding address for which trigger of the data forwarding is recommended;

at least one cell identifier for which trigger of the data forwarding is not recommended;

at least one data forwarding address for which trigger of the data forwarding is not recommended;

at least one cell measurement reported by the terminal device; or

location information of the terminal device.

In an implementation, the first network device further includes a third receiving unit 1630.

The third receiving unit 1630 is configured to receive auxiliary information reported by the terminal device, where the auxiliary information is related to conditional handover candidate cells.

In an implementation, the auxiliary information includes at least one of:

a cell identifier of a cell that will most be likely to perform a next conditional handover as the terminal device deduces;

cell identifiers of cells that are likely to perform the next conditional handover as the terminal device deduces, with a maximum of M cell identifiers reported;

cell identifiers of N1 cells with best measurements among conditional handover candidate cells measured by the terminal device;

the cell identifiers and corresponding measurements of the N1 cells with the best measurements among the conditional handover candidate cells measured by the terminal device;

cell identifiers of cells, each having a measurement greater than or equal to a first threshold, among the conditional handover candidate cells measured by the terminal device;

the cell identifiers and corresponding measurements of the cells, each having a measurement greater than or equal to the first threshold, among the conditional handover candidate cells measured by the terminal device;

cell identifiers of cells, each having a measurement greater than or equal to a second threshold, among the conditional handover candidate cells measured by the terminal device, with a maximum of N2 cell identifiers reported;

the cell identifiers and corresponding measurements of the cells, each having a measurement greater than or equal to the second threshold, among the conditional handover candidate cells measured by the terminal device, with a maximum of N2 cells reported;

cell identifiers of cells, each having a ratio of a measurement to a triggering threshold of a corresponding conditional handover event that is greater than or equal to a third threshold, among the conditional handover candidate cells measured by the terminal device;

the cell identifiers and corresponding measurements of the cells, each having a ratio of a measurement to the triggering threshold of the corresponding conditional handover event that is greater than or equal to the third threshold, among the conditional handover candidate cells measured by the terminal device;

cell identifiers of cells, each having a ratio of a measurement to the triggering threshold of the corresponding conditional handover event that is greater than or equal to a fourth threshold, among the conditional handover candidate cells measured by the terminal device, with a maximum of N3 cells reported; or

the cell identifiers and corresponding measurements of the cells, each having a ratio of a measurement to the triggering threshold of the corresponding conditional handover event that is greater than or equal to the fourth threshold, among the conditional handover candidate cells measured by the terminal device, with the maximum of N3 cells reported.

In an implementation, the sending unit 1510 is further configured to send fourth indication information to the terminal device. The fourth indication information is configured to trigger the terminal device to report the auxiliary information.

In an implementation, the sending unit 1510 is further configured to send event configuration information to the terminal device. The event configuration information is configured to configure configurations associated with an event related to reporting of the auxiliary information.

Herein the event configuration information includes at least one of:

An event type identifier corresponding to the event related to the reporting of the auxiliary information;

A reporting period corresponding to the event related to the reporting of the auxiliary information;

A number of reports corresponding to the event related to the reporting of the auxiliary information; or

A threshold of triggering the reporting corresponding to the event related to the reporting of the auxiliary information.

The first network device 1500 according to the embodiment of the disclosure can implement the corresponding functions of the first network device in the aforementioned method embodiments. The corresponding processes, functions, implementations, and beneficial effects of each module (sub-module, unit, component, etc.) in the first network device 1500 may refer to the corresponding description in the aforementioned method embodiments, and will not be repeated herein. It should be noted that the functions described with respect to each module (sub-module, unit, component, etc.) in the first network device 1500 in the embodiment of the disclosure may be implemented by different modules (sub-modules, units, components, etc.), or may be implemented by the same module (sub-module, unit, component, etc.).

FIG. 17 is a schematic structural diagram of a second network device 1700 according to an embodiment of the disclosure. The second network device 1700 may optionally be applied to the system shown in FIG. 1, but is not limited thereto. The second network device 1700 includes at least part of the following.

A receiving unit 1710 is configured to receive a first message sent by a first network device, where the first message is configured for conditional handover control.

Herein the first network device is at least one of a primary cell (PCell), a master node (MN), or a secondary node (SN) currently connected to a terminal device; and the second network device is a conditional handover candidate cell associated with the terminal device.

In an implementation, a relationship between the first network device and the second network device includes at least one of:

the first network device is the PCell currently connected to the terminal device, and the second network device is a PCell related to a conditional handover associated with the terminal device;

the first network device is the MN currently connected to the terminal device, and the second network device is an MN related to the conditional handover associated with the terminal device; or

the first network device is the MN or the SN currently connected to the terminal device, and the second network device is an SN related to the conditional handover associated with the terminal device.

In an implementation, the first message includes at least one of:

a cell identifier corresponding to a conditional handover candidate cell accessed by the terminal device;

first indication information, configured to indicate that the conditional handover candidate cell accessed by the terminal device is not a cell corresponding to the second network device;

second indication information, configured to request the second network device to provide a data forwarding address;

third indication information, configured to request the second network device to agree to continue serving as the conditional handover candidate cell for the terminal device;

cell configuration information for the terminal device in a cell connected to the terminal device before conditional handover, where the cell connected to the terminal device before the conditional handover is at least one of a cell corresponding to an SN, a cell corresponding to an MN, or a PCell connected to the terminal device before the conditional handover;

a cell measurement reported by the terminal device;

location information of the terminal device; or

historical serving cell information of the terminal device.

In an implementation, the first message is configured to at least one of:

request the second network device to provide a data forwarding address;

request the second network device to agree to continue serving as the conditional handover candidate cell for the terminal device; or

indicate to the second network device that the terminal device has performed a conditional handover.

In an implementation, as shown in FIG. 18, the second network device further includes a sending unit 1810.

The sending unit 1810 is configured to send a response message to the first message to the first network device.

Herein the response message to the first message is configured to notify the first network device to remove configuration information reserved by the second network device for the terminal device from conditional handover configuration information configured for the terminal device; or the response message to the first message is configured to notify the first network device that the second network device agrees to continue serving as the conditional handover candidate cell for the terminal device.

In an implementation, in case that the response message to the first message is configured to notify the first network device that the second network device agrees to continue serving as the conditional handover candidate cell for the terminal device, the response message to the first message includes at least one of:

a data forwarding address allocated by the second network device;

cell configuration information configured or updated for the terminal device by a cell corresponding to the second network device;

valid duration information for the cell corresponding to the second network device agreeing to continue serving as the conditional handover candidate cell for the terminal device; or

a cell identifier allocated by the second network device for itself as the conditional handover candidate cell.

The second network device 1700 according to the embodiment of the disclosure can implement the corresponding functions of the second network device in the aforementioned method embodiments. The corresponding processes, functions, implementations, and beneficial effects of each module (sub-module, unit, component, etc.) in the second network device 1700 may refer to the corresponding description in the aforementioned method embodiments, and will not be repeated herein. It should be noted that the functions described with respect to each module (sub-module, unit, component, etc.) in the second network device 1700 in the embodiment of the disclosure may be implemented by different modules (sub-modules, units, components, etc.), or may be implemented by the same module (sub-module, unit, component, etc.).

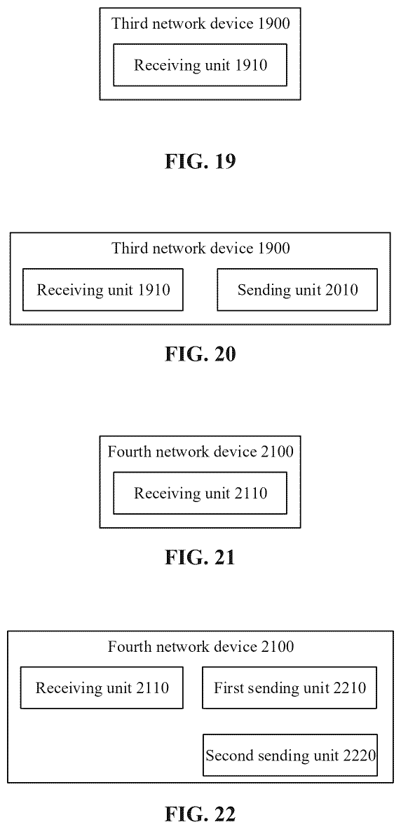

FIG. 19 is a schematic structural diagram of a third network device 1900 according to an embodiment of the disclosure. The third network device 1900 may optionally be applied to the system shown in FIG. 1, but is not limited thereto. The third network device 1900 includes at least part of the following.

A receiving unit 1910 is configured to receive a first message sent by a first network device, where the first message is configured for conditional handover control.

Herein the first network device is at least one of a primary cell (PCell), a master node (MN), or a secondary node (SN) currently connected to a terminal device; and the third network device is at least one of a PCell, an MN, or an SN connected to the terminal device before conditional handover of the terminal device.

In an implementation, the first message includes at least one of:

a cell identifier corresponding to a conditional handover candidate cell accessed by the terminal device;

first indication information, configured to indicate that the conditional handover candidate cell accessed by the terminal device is not a cell corresponding to the third network device;

second indication information, configured to request the third network device to provide a data forwarding address;

third indication information, configured to request the third network device to agree to serve as a conditional handover candidate cell for the terminal device;

cell configuration information for the terminal device in a cell connected to the terminal device before the conditional handover, where the cell connected to the terminal device before the conditional handover is at least one of a cell corresponding to the SN, a cell corresponding to the MN, or the PCell connected to the terminal device before the conditional handover;

a cell measurement reported by the terminal device;

location information of the terminal device; or

historical serving cell information of the terminal device.

In an implementation, the first message is configured to at least one of:

Request the third network device to provide a data forwarding address;

Request the third network device to agree to serve as a conditional handover candidate cell for the terminal device; or

Indicate to the third network device that the terminal device has performed the conditional handover.

In an implementation, as shown in FIG. 20, the third network device further includes a sending unit 2010.

The sending unit 2010 is configured to send a response message to the first message to the first network device.

Herein the response message to the first message is configured to notify the first network device to remove configuration information reserved by the third network device for the terminal device from conditional handover configuration information configured for the terminal device; or the response message to the first message is configured to notify the first network device that the third network device agrees to serve as a conditional handover candidate cell for the terminal device.

In an implementation, in case that the response message to the first message is configured to notify the first network device that the third network device agrees to serve as the conditional handover candidate cell for the terminal device, the response message to the first message includes at least one of:

A data forwarding address allocated by the third network device;

Cell configuration information configured or updated for the terminal device by a cell corresponding to the third network device;

Valid duration information for the cell corresponding to the third network device agreeing to serve as the conditional handover candidate cell for the terminal device; or

A cell identifier allocated by the third network device for itself as the conditional handover candidate cell.

In an implementation, the receiving unit 1910 is further configured for the third network device to receive a third message sent by the first network device. The third message is configured to notify the third network device to stop sending data to the terminal device.

The third network device 1900 according to the embodiment of the disclosure can implement the corresponding functions of the third network device in the aforementioned method embodiments. The corresponding processes, functions, implementations, and beneficial effects of each module (sub-module, unit, component, etc.) in the third network device 1900 may refer to the corresponding description in the aforementioned method embodiments, and will not be repeated herein. It should be noted that the functions described with respect to each module (sub-module, unit, component, etc.) in the third network device 1900 in the embodiment of the disclosure may be implemented by different modules (sub-modules, units, components, etc.), or may be implemented by the same module (sub-module, unit, component, etc.).

FIG. 21 is a schematic structural diagram of a fourth network device 2100 according to an embodiment of the disclosure. The fourth network device 2100 may optionally be applied to the system shown in FIG. 1, but is not limited thereto. The fourth network device 2100 includes at least part of the following.

A receiving unit 2110 is configured to receive a fourth message sent by a first network device, where the fourth message is configured for conditional handover control.

Herein the first network device is at least one of a primary cell (PCell), a master node (MN), or a secondary node (SN) currently connected to a terminal device; and the fourth network device is at least one of a PCell, an MN, or an SN connected to the terminal device after conditional handover of the terminal device.

In an implementation, the fourth message includes:

A data forwarding address allocated by a second network device and/or a third network device; and/or

Valid duration information for a cell corresponding to the second network device and/or the third network device serving as a conditional handover candidate cell for the terminal device.

In an implementation, the receiving unit 2110 is further configured to receive a fifth message sent by the first network device, where the fifth message is configured to assist at least one of the PCell, the MN, or the SN currently connected to the terminal device in data forwarding.

In an implementation, the fifth message includes at least one of:

at least one cell identifier for which trigger of the data forwarding is recommended;

at least one data forwarding address for which trigger of the data forwarding is recommended;

at least one cell identifier for which trigger of the data forwarding is not recommended;

at least one data forwarding address for which trigger of the data forwarding is not recommended;

at least one cell measurement reported by the terminal device; or

location information of the terminal device.

In an implementation, as shown in FIG. 22, the fourth network device further includes a first sending unit 2210.

The first sending unit 2210 is configured to send a second message to the first network device, where the second message is configured to notify the first network device that the terminal device has successfully accessed or switched to the fourth network device.

In an implementation, the receiving unit 2110 is further configured to receive auxiliary information reported by the terminal device, where the auxiliary information is related to conditional handover candidate cells.

In an implementation, the auxiliary information includes at least one of:

a cell identifier of a cell that will most be likely to perform a next conditional handover as the terminal device deduces;

cell identifiers of cells that are likely to perform the next conditional handover as the terminal device deduces, with a maximum of M cell identifiers reported;

cell identifiers of N1 cells with best measurements among conditional handover candidate cells measured by the terminal device;

the cell identifiers and corresponding measurements of the NI cells with the best measurements among the conditional handover candidate cells measured by the terminal device;

cell identifiers of cells, each having a measurement greater than or equal to a first threshold, among the conditional handover candidate cells measured by the terminal device;

the cell identifiers and corresponding measurements of the cells, each having a measurement greater than or equal to the first threshold, among the conditional handover candidate cells measured by the terminal device;

cell identifiers of cells, each having a measurement greater than or equal to a second threshold, among the conditional handover candidate cells measured by the terminal device, with a maximum of N2 cell identifiers reported;

the cell identifiers and corresponding measurements of the cells, each having a measurement greater than or equal to the second threshold, among the conditional handover candidate cells measured by the terminal device, with a maximum of N2 cells reported;

cell identifiers of cells, each having a ratio of a measurement to a triggering threshold of a corresponding conditional handover event that is greater than or equal to a third threshold, among the conditional handover candidate cells measured by the terminal device;

the cell identifiers and corresponding measurements of the cells, each having a ratio of a measurement to the triggering threshold of the corresponding conditional handover event that is greater than or equal to the third threshold, among the conditional handover candidate cells measured by the terminal device;

cell identifiers of cells, each having a ratio of a measurement to the triggering threshold of the corresponding conditional handover event that is greater than or equal to a fourth threshold, among the conditional handover candidate cells measured by the terminal device, with a maximum of N3 cells reported; or

the cell identifiers and corresponding measurements of the cells, each having a ratio of a measurement to the triggering threshold of the corresponding conditional handover event that is greater than or equal to the fourth threshold, among the conditional handover candidate cells measured by the terminal device, with the maximum of N3 cells reported.

In an implementation, the fourth network device further includes a second sending unit 2220.

The second sending unit 2220 is configured to send fourth indication information to the terminal device, where the fourth indication information is configured to trigger the terminal device to report the auxiliary information.

In an implementation, the second sending unit 2220 is further configured to send event configuration information to the terminal device, where the event configuration information is configured to configure configurations associated with an event related to reporting of the auxiliary information.

Herein the event configuration information includes at least one of:

an event type identifier corresponding to the event related to the reporting of the auxiliary information;

a reporting period corresponding to the event related to the reporting of the auxiliary information;

a number of reports corresponding to the event related to the reporting of the auxiliary information; or

a threshold of triggering the reporting corresponding to the event related to the reporting of the auxiliary information.

The fourth network device 2100 according to the embodiment of the disclosure can implement the corresponding functions of the fourth network device in the aforementioned method embodiments. The corresponding processes, functions, implementations, and beneficial effects of each module (sub-module, unit, component, etc.) in the fourth network device 2100 may refer to the corresponding description in the aforementioned method embodiments, and will not be repeated herein. It should be noted that the functions described with respect to each module (sub-module, unit, component, etc.) in the fourth network device 2100 in the embodiment of the disclosure may be implemented by different modules (sub-modules, units, components, etc.), or may be implemented by the same module (sub-module, unit, component, etc.).

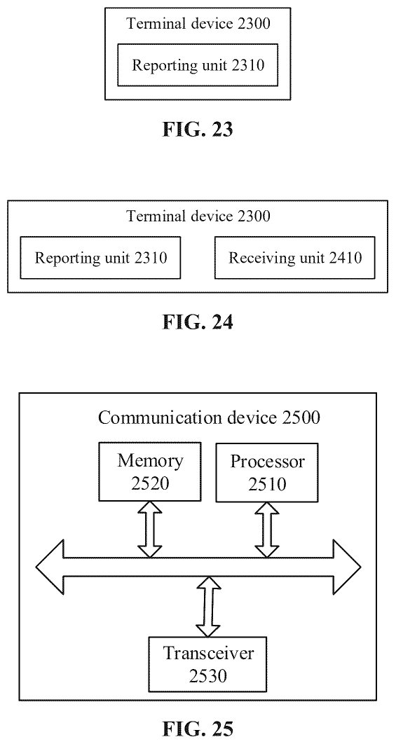

FIG. 23 is a schematic structural diagram of a terminal device 2300 according to an embodiment of the disclosure. The terminal device 2300 may optionally be applied to the system shown in FIG. 1, but is not limited thereto. The terminal device 2300 includes at least part of the following.

A reporting unit 2310 is configured to report auxiliary information to a first network device and/or a fourth network device. The auxiliary information is related to conditional handover candidate cells.

Herein the first network device is at least one of a primary cell (PCell), a master node (MN), or a secondary node (SN) currently connected to the terminal device; and the fourth network device is at least one of a PCell, an MN, or an SN connected to the terminal device after the conditional handover of the terminal device.

In an implementation, the auxiliary information includes at least one of:

A cell identifier of a cell that will most be likely to perform a next conditional handover as the terminal device deduces;

Cell identifiers of cells that are likely to perform the next conditional handover as the terminal device deduces, with a maximum of M cell identifiers reported;

Cell identifiers of N1 cells with best measurements among conditional handover candidate cells measured by the terminal device;

The cell identifiers and corresponding measurements of the N1 cells with the best measurements among the conditional handover candidate cells measured by the terminal device;

Cell identifiers of cells, each having a measurement greater than or equal to a first threshold, among the conditional handover candidate cells measured by the terminal device;

The cell identifiers and corresponding measurements of the cells, each having a measurement greater than or equal to the first threshold, among the conditional handover candidate cells measured by the terminal device;

Cell identifiers of cells, each having a measurement greater than or equal to a second threshold, among the conditional handover candidate cells measured by the terminal device, with a maximum of N2 cell identifiers reported;

The cell identifiers and corresponding measurements of the cells, each having a measurement greater than or equal to the second threshold, among the conditional handover candidate cells measured by the terminal device, with a maximum of N2 cells reported;

Cell identifiers of cells, each having a ratio of a measurement to a triggering threshold of a corresponding conditional handover event that is greater than or equal to a third threshold, among the conditional handover candidate cells measured by the terminal device;

The cell identifiers and corresponding measurements of the cells, each having a ratio of a measurement to the triggering threshold of the corresponding conditional handover event that is greater than or equal to the third threshold, among the conditional handover candidate cells measured by the terminal device;

Cell identifiers of cells, each having a ratio of a measurement to the triggering threshold of the corresponding conditional handover event that is greater than or equal to a fourth threshold, among the conditional handover candidate cells measured by the terminal device, with a maximum of N3 cells reported; or

The cell identifiers and corresponding measurements of the cells, each having a ratio of a measurement to the triggering threshold of the corresponding conditional handover event that is greater than or equal to the fourth threshold, among the conditional handover candidate cells measured by the terminal device, with the maximum of N3 cells reported.

In an implementation, as shown in FIG. 24, the terminal device further includes a receiving unit 2410.

The receiving unit 2410 is configured to receive fourth indication information sent by the first network device and/or the fourth network device, where the fourth indication information is configured to trigger the terminal device to report the auxiliary information.

In an implementation, the reporting of the auxiliary information by the terminal device is triggered when a default event is satisfied or when an event configured by the first network device and/or the fourth network device is satisfied.

In an implementation, the receiving unit 2410 is further configured to receive event configuration information sent by the first network device and/or the fourth network device. The event configuration information is configured to configure configurations associated with an event related to the reporting of the auxiliary information.

Herein the event configuration information includes at least one of:

An event type identifier corresponding to the event related to the reporting of the auxiliary information;

A reporting period corresponding to the event related to the reporting of the auxiliary information;

A number of reports corresponding to the event related to the reporting of the auxiliary information; or

A threshold of triggering the reporting corresponding to the event related to the reporting of the auxiliary information.

The terminal device 2300 according to the embodiment of the disclosure can implement the corresponding functions of the terminal device in the aforementioned method embodiments. The corresponding processes, functions, implementations, and beneficial effects of each module (sub-module, unit, component, etc.) in the terminal device 2300 may refer to the corresponding description in the aforementioned method embodiments, and will not be repeated herein. It should be noted that the functions described with respect to each module (sub-module, unit, component, etc.) in the terminal device 2300 in the embodiment of the disclosure may be implemented by different modules (sub-modules, units, components, etc.), or may be implemented by the same module (sub-module, unit, component, etc.).

FIG. 25 is a schematic structural diagram of a communication device 2500 according to an embodiment of the disclosure. The communication device 2500 includes a processor 2510, and the processor 2510 may call and run a computer program from a memory to cause the communication device 2500 to implement the method in the embodiments of the disclosure.

In an implementation, the communication device 2500 may further include a memory 2520. Herein the processor 2510 may call and run a computer program from the memory 2520 to cause the communication device 2500 to implement the method in the embodiments of the disclosure.

Herein the memory 2520 may be a separate device independent of the processor 2510, or may be integrated in the processor 2510.

In an implementation, the communication device 2500 may further include a transceiver 2530. The processor 2510 may control the transceiver 2530 to communicate with other devices, in particular to send information or data to other devices, or to receive information or data sent by other devices.

Herein the transceiver 2530 may include a transmitter and a receiver. The transceiver 2530 may further include one or more antennas.

In an implementation, the communication device 2500 may be a network device in the embodiments of the disclosure, and the communication device 2500 may implement the corresponding processes implemented by the network device in the various methods in the embodiments of the disclosure, and these processes will not be repeated here for the sake of brevity.

In an implementation, the communication device 2500 may be a terminal device in the embodiments of the disclosure, and the communication device 2500 may implement the corresponding processes implemented by the terminal device in the various methods in the embodiments of the disclosure, and these processes will not be repeated here for the sake of brevity.

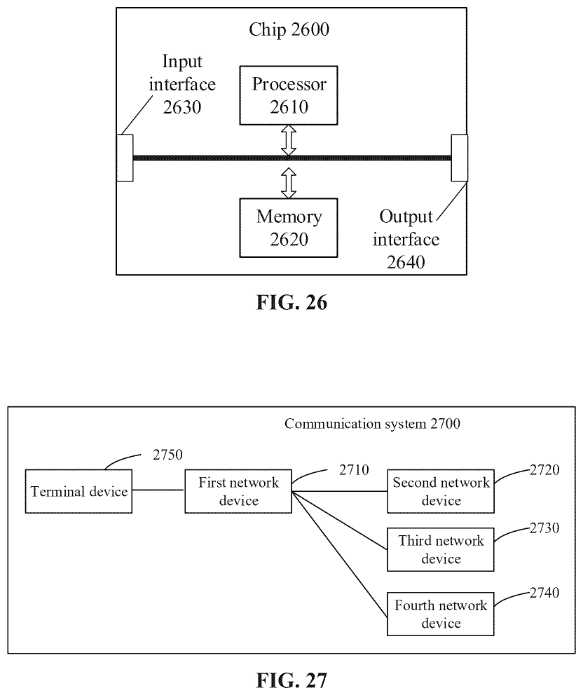

FIG. 26 is a schematic structural diagram of a chip 2600 according to an embodiment of the disclosure. The chip 2600 includes a processor 2610, and the processor 2610 may call and run a computer program from a memory to implement the method in the embodiments of the disclosure.

In an implementation, the chip 2600 may further include a memory 2620. Herein the processor 2610 may call and run a computer program from the memory 2620 to implement a method performed by a terminal device or a network device in the embodiments of the disclosure.

Herein the memory 2620 may be a separate device independent of the processor 2610, or may be integrated in the processor 2610.

In an implementation, the chip 2600 may further include an input interface 2630. The processor 2610 may control the input interface 2630 to communicate with other devices or chips, in particular to obtain information or data sent by other devices or chips.

In an implementation, the chip 2600 may further include an output interface 2640. The processor 2610 may control the output interface 2640 to communicate with other devices or chips, in particular to output information or data to other devices or chips.

In an implementation, the chip may be applied to a network device in the embodiments of the disclosure, and the chip may implement the corresponding processes implemented by the network device in the various methods in the embodiments of the disclosure, and these processes will not be repeated here for the sake of brevity.

In an implementation, the chip may be applied to a terminal device in the embodiments of the disclosure, and the chip may implement the corresponding processes implemented by the terminal device in the various methods in the embodiments of the disclosure, and these processes will not be repeated here for the sake of brevity.

Chips applied to the network devices and the terminal device may be the same chip or different chips.

It should be understood that the chip mentioned in the embodiments of the disclosure may also be referred to as a system level chip, a system chip, a chip system, a system on chip, or the like.

The processor mentioned above may be a general purpose processor, a digital signal processor (DSP), a field programmable gate array (FPGA), an application specific integrated circuit (ASIC), or other programmable logic device, transistor logic device, discrete hardware component, etc. Herein the general purpose processor mentioned above may be a microprocessor or any conventional processor or the like.

The memory mentioned above may be a transitory memory or a non-transitory memory, or may include both the transitory memory and non-transitory memory. The non-transitory memory may be a read-only memory (ROM), a programmable ROM (PROM), an erasable PROM (EPROM), an electrically EPROM (EEPROM), or a flash memory. The transitory memory may be a random access memory (RAM).

It should be understood that the above memory is an exemplary but not limiting example. For example, the memory in the embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), or a direct rambus RAM (DR RAM), etc. That is, the memory in the embodiments of the disclosure is intended to include, but is not limited to, these and any other suitable type of memory.

FIG. 27 is a schematic block diagram of a communication system 2700 according to an embodiment of the disclosure. The communication system 2700 includes a first network device 2710 and a second network device 2720.

The first network device 2710 is configured to perform the method for controlling the conditional handover performed by the first network device in the above embodiment.

The second network device 2720 is configured to perform the method for controlling the conditional handover performed by the second network device in the above embodiment.

In an implementation, the communication system further includes a third network device 2730.

The third network device 2730 is configured to perform the method for controlling the conditional handover performed by the third network device in the above embodiment.

In an implementation, the communication system further includes a fourth network device 2740.

The fourth network device 2740 is configured to perform the method for controlling the conditional handover performed by the fourth network device in the above embodiment.

In an implementation, the communication system further includes a terminal device 2750.

The terminal device 2750 is configured to perform the method for controlling the conditional handover performed by the terminal device in the above embodiment.

The above embodiments may be implemented wholly or partially through software, hardware, firmware, or any combination thereof. When implemented using software, the above embodiments may be implemented wholly or partially in the form of a computer program product. The computer program product includes one or more computer instructions. When the computer program instructions are loaded and executed on a computer, the processes or functions in the embodiments of the disclosure are produced wholly or partially. The computer may be a general purpose computer, a special purpose computer, a computer network, or other programmable device. The computer instructions may be stored in a computer-readable storage medium, or transmitted from one computer-readable storage medium to another computer-readable storage medium, for example, the computer instructions may be transmitted from one website site, computer, server, or data center to another website site, computer, server, or data center via wired (e.g., coaxial cable, fiber optic, digital subscriber line (DSL)) or wireless (e.g., infrared, wireless, microwave, etc.) means. The computer-readable storage medium may be any available medium accessible by the computer, or a data storage device (e.g., a server, a data center, etc.) that integrated with one or more available media. One of the available media may be a magnetic medium (e.g., a floppy disk, a hard disk, a magnetic tape), an optical medium (e.g., a DVD), or a semiconductor medium (e.g., a solid state disk (SSD)), etc.

It should be understood that in the various embodiments of the disclosure, the sequence numbers of the aforementioned processes do not imply the sequence of execution, and the sequence of execution of the processes should be determined by their function and internal logic, and should not impose any limitation on the implementation processes in the embodiments of the disclosure.

It may be clearly understood by those skilled in the art that for convenience and conciseness of the description, the specific operating processes of the aforementioned systems, devices, and units may refer to the corresponding processes in the aforementioned method embodiments, and will not be repeated herein.

The foregoing descriptions are merely specific embodiments of the disclosure, but the scope of protection of the disclosure is not limited thereto. Any change or replacement readily contemplated by any person skilled in the art within the technical scope disclosed by the disclosure shall fall within the scope of protection of the disclosure. Therefore, the scope of protection of the disclosure shall be subject to the scope of protection of the claims.

1. A method for controlling a conditional handover, comprising:
receiving, by a fourth network device, a fourth message sent by a first network device, wherein the fourth message is configured for conditional handover control;
wherein the first network device is at least one of a primary cell (PCell), a master node (MN), or a secondary node (SN) currently connected to a terminal device; and the fourth network device is at least one of a PCell, an MN, or an SN connected to the terminal device after conditional handover of the terminal device.

2. The method of claim 1, wherein the fourth message comprises:
a data forwarding address allocated by a second network device and/or a third network device; and/or
valid duration information for a cell corresponding to the second network device and/or the third network device serving as a conditional handover candidate cell for the terminal device.

3. The method of claim 2, wherein the second network device is a conditional handover candidate cell associated with the terminal device, and the third network device is at least one of a PCell, an MN, or an SN connected to the terminal device before conditional handover of the terminal device.

4. The method of claim 2, wherein a relationship between the first network device and the second network device comprises at least one of:
the first network device is the PCell currently connected to the terminal device, and the second network device is a PCell related to the conditional handover associated with the terminal device;
the first network device is the MN currently connected to the terminal device, and the second network device is an MN related to the conditional handover associated with the terminal device; or
the first network device is the MN or the SN currently connected to the terminal device, and the second network device is an SN related to the conditional handover associated with the terminal device.

5. The method of claim 2, wherein the data forwarding address is included in a response message to a first message, which is sent by the second network device and/or the third network device in response to the first message from the first network device,
the first message is configured for conditional handover control; and
the response message to the first message is configured to notify the first network device that the second network device and/or the third network device agree to serve as a conditional handover candidate cell for the terminal device.

6. The method of claim 5, wherein the response message to the first message further comprises at least one of:
cell configuration information configured or updated for the terminal device by a cell corresponding to the second network device and/or the third network device;
valid duration information for the cell corresponding to the second network device and/or the third network device agreeing to serve as the conditional handover candidate cell for the terminal device; or
a cell identifier allocated by the second network device and/or the third network device for itself as the conditional handover candidate cell.

7. The method of claim 5, wherein the first message comprises at least one of:
a cell identifier corresponding to a conditional handover candidate cell accessed by the terminal device;
first indication information, configured to indicate that the conditional handover candidate cell accessed by the terminal device is not a cell corresponding to the second network device and/or the third network device;
second indication information, configured to request the second network device and/or the third network device to provide a data forwarding address;
third indication information, configured to request the second network device and/or the third network device to agree to serve as the conditional handover candidate cell for the terminal device;
cell configuration information for the terminal device in a cell connected to the terminal device before the conditional handover, wherein the cell connected to the terminal device before the conditional handover is at least one of a cell corresponding to an SN, a cell corresponding to an MN, or a PCell connected to the terminal device before the conditional handover;
a cell measurement reported by the terminal device;
location information of the terminal device; or
historical serving cell information of the terminal device.

8. The method of claim 5, wherein the first message is configured to at least one of:
request the second network device and/or the third network device to provide a data forwarding address;
request the second network device and/or the third network device to agree to serve as a conditional handover candidate cell for the terminal device; or
indicate to the second network device and/or the third network device that the terminal device has performed the conditional handover.

9. A fourth network device, comprising: a processor and a memory, wherein the memory is configured to store a computer program, and the processor is configured to call and run the computer program stored in the memory to cause the fourth network device to:
receive a fourth message sent by a first network device, wherein the fourth message is configured for conditional handover control;
wherein the first network device is at least one of a primary cell (PCell), a master node (MN), or a secondary node (SN) currently connected to a terminal device; and the fourth network device is at least one of a PCell, an MN, or an SN connected to the terminal device after conditional handover of the terminal device.

10. The fourth network device of claim 9, wherein the fourth message comprises:
a data forwarding address allocated by a second network device and/or a third network device; and/or
valid duration information for a cell corresponding to the second network device and/or the third network device serving as a conditional handover candidate cell for the terminal device.

11. The fourth network device of claim 10, wherein the second network device is a conditional handover candidate cell associated with the terminal device, and the third network device is at least one of a PCell, an MN, or an SN connected to the terminal device before conditional handover of the terminal device, and
wherein a relationship between the first network device and the second network device comprises at least one of:
the first network device is the PCell currently connected to the terminal device, and the second network device is a PCell related to the conditional handover associated with the terminal device;
the first network device is the MN currently connected to the terminal device, and the second network device is an MN related to the conditional handover associated with the terminal device; or
the first network device is the MN or the SN currently connected to the terminal device, and the second network device is an SN related to the conditional handover associated with the terminal device.

12. The fourth network device of claim 11, wherein the data forwarding address is included in a response message to a first message, which is sent by the second network device and/or the third network device in response to the first message from the first network device,
the first message is configured for conditional handover control;
the response message to the first message is configured to notify the first network device that the second network device and/or the third network device agree to serve as a conditional handover candidate cell for the terminal device; and
the response message to the first message further comprises at least one of:
cell configuration information configured or updated for the terminal device by a cell corresponding to the second network device and/or the third network device;
valid duration information for the cell corresponding to the second network device and/or the third network device agreeing to serve as the conditional handover candidate cell for the terminal device; or
a cell identifier allocated by the second network device and/or the third network device for itself as the conditional handover candidate cell.

13. The fourth network device of claim 12, wherein the first message comprises at least one of:
a cell identifier corresponding to a conditional handover candidate cell accessed by the terminal device;
first indication information, configured to indicate that the conditional handover candidate cell accessed by the terminal device is not a cell corresponding to the second network device and/or the third network device;
second indication information, configured to request the second network device and/or the third network device to provide a data forwarding address;
third indication information, configured to request the second network device and/or the third network device to agree to serve as the conditional handover candidate cell for the terminal device;
cell configuration information for the terminal device in a cell connected to the terminal device before the conditional handover, wherein the cell connected to the terminal device before the conditional handover is at least one of a cell corresponding to an SN, a cell corresponding to an MN, or a PCell connected to the terminal device before the conditional handover;
a cell measurement reported by the terminal device;
location information of the terminal device; or
historical serving cell information of the terminal device.

14. The fourth network device of claim 12, wherein the first message is configured to at least one of:
request the second network device and/or the third network device to provide a data forwarding address;
request the second network device and/or the third network device to agree to serve as a conditional handover candidate cell for the terminal device; or
indicate to the second network device and/or the third network device that the terminal device has performed the conditional handover.

15. A first network device, comprising: a processor and a memory, wherein the memory is configured to store a computer program, and the processor is configured to call and run the computer program stored in the memory to cause the first network device to:
send a fourth message to a fourth network device, wherein the fourth message is configured for conditional handover control;
wherein the first network device is at least one of a primary cell (PCell), a master node (MN), or a secondary node (SN) currently connected to a terminal device; and the fourth network device is at least one of a PCell, an MN, or an SN connected to the terminal device after conditional handover of the terminal device.

16. The first network device of claim 15, wherein the fourth message comprises:
a data forwarding address allocated by a second network device and/or a third network device; and/or
valid duration information for a cell corresponding to the second network device and/or the third network device serving as a conditional handover candidate cell for the terminal device.

17. The first network device of claim 15, wherein the processor is further configured to call and run the computer program stored in the memory to cause the first network device to:
send a first message to a second network device and/or a third network device, wherein the first message is configured for conditional handover control;
wherein the second network device is a conditional handover candidate cell associated with the terminal device, and the third network device is at least one of a PCell, an MN, or an SN connected to the terminal device before conditional handover of the terminal device.

18. The first network device of claim 17, wherein the first message is configured to at least one of:
request the second network device and/or the third network device to provide a data forwarding address;
request the second network device and/or the third network device to agree to serve as a conditional handover candidate cell for the terminal device; or
indicate to the second network device and/or the third network device that the terminal device has performed the conditional handover.

19. The first network device of claim 17, wherein the processor is further configured to call and run the computer program stored in the memory to cause the first network device to:
receive a response message to the first message sent by the second network device and/or the third network device;
wherein the response message to the first message is configured to notify the first network device to remove configuration information reserved by the second network device and/or the third network device for the terminal device from conditional handover configuration information configured for the terminal device; or the response message to the first message is configured to notify the first network device that the second network device and/or the third network device agree to serve as a conditional handover candidate cell for the terminal device,
wherein in case that the response message to the first message is configured to notify the first network device that the second network device and/or the third network device agree to serve as the conditional handover candidate cell for the terminal device, the response message to the first message comprises at least one of:
a data forwarding address allocated by the second network device and/or the third network device;
cell configuration information configured or updated for the terminal device by a cell corresponding to the second network device and/or the third network device;
valid duration information for the cell corresponding to the second network device and/or the third network device agreeing to serve as the conditional handover candidate cell for the terminal device; or
a cell identifier allocated by the second network device and/or the third network device for itself as the conditional handover candidate cell.

20. The first network device of claim 15, wherein the processor is further configured to call and run the computer program stored in the memory to cause the first network device to:
send a third message to a third network device, wherein the third message is configured to notify the third network device to stop sending data to the terminal device, and the third network device is at least one of a PCell, an MN, or an SN connected to the terminal device before conditional handover of the terminal device.
